(19) United States
(12) Patent Application Publication
(10) Pub. No.: US 2013/0083238 A1
(43) Pub. Date: Apr. 4, 2013

(54) Solar powered camera

(71) Applicant: Alex P. Glynn, Orlando, FL (US)

(72) Inventor: Alex P. Glynn, Orlando, FL (US)

(73) Assignee: GLYNNTECH, INC.

(21) Appl. No.: 13/200,889

(22) Filed: Oct. 4, 2011

(51) Int. Cl. H04N 5/225

(52) U.S. Cl. 348/372; 348/E05.024

(57) ABSTRACT

A present invention solar power camera includes: a) a digital camera main housing; b) digital camera internal mechanisms, including imaging and storage processors located within the main housing, imaging and storage controls, and a lens connected to the imaging processor and located on the main housing; c) a rechargeable power storage unit connected to the digital camera internal mechanisms; and, d) at least one solar cell panel connected to the rechargeable power storage unit and movably connected to said main housing, said at least one solar cell panel having a first position, being a closed position, and having a second position, being an open position; wherein the at least one solar cell panel is movable from the first position to the second position for solar recharging of the rechargeable power storage unit, and is movable from the second position to the first position for storage.

### BACKGROUND OF INVENTION

a. Field of Invention

The invention relates generally to alternative energy sources. More specifically, the invention relates to recharging rechargeable electronic devices using solar energy.

b. Description of Related Art

The following patents are representative of the field pertaining to the present invention:

U.S. Pat. No. 7,805,244 B2 to Park et al. describes an attitude correction apparatus for an Inertial Navigation System (INS) using a camera-type solar sensor. The present invention relates to a system for correcting errors occurring in an inertial navigation system, in which inertial sensors, such as gyroscopes and accelerometers are combined with each other to calculate the attitude, velocity, and position of an airplane, and to an apparatus for utilizing a sun-line of sigh vector, generated by a camera-type solar sensor, that uses images of the moving sun, and the output value of the inertial navigation system, thus correcting the attitude of an airplane and the errors of sensors. The attitude correction apparatus of the present invention includes a camera-type solar sensor for detecting the sun, a signal processing unit for receiving and synchronizing information, and a data collection processing unit for performing post-processing on information, thus correcting an error.

U.S. Pat. No. 5,825,157 to Suzuki describes a camera having a secondary battery charged by a solar battery, and overcharging prevention circuit for preventing overcharging to the second battery, and a control circuit for driving the over-charging prevention circuit when the secondary battery is charged, or a charging device for a camera of this type.

U.S. Pat. No. 5,424,800 to Suzuki describes a camera which includes a solar battery, a secondary battery charged by the solar battery, a battery-checking circuit for checking a charged state of the secondary battery, an informing device for informing the charged state of the secondary battery checked by the battery-checking circuit, and a clock for operating the battery-checking circuit at predetermined intervals.

U.S. Pat. No. 4,328,456 to Suzuki et al. describes a charge circuit for secondary batteries. The charge circuit encompasses a control circuit having as a power source accumulators chargeable with the current resulting from the electromotive force of a plural number of solar batteries built in a camera. The plural number of the solar batteries are distributed at a plural number of portions on the exterior of the camera. The plural number of the solar batteries are connected in series or parallel or, in accordance with necessity, a serial-parallel connection change-over of the solar batteries is carried out. Circuits for comparing the level at both terminals of each solar battery and for short-circuiting the terminal in accordance with the result of the comparison are provided.

Notwithstanding the prior art, the present invention is neither taught nor rendered obvious thereby.

### SUMMARY OF INVENTION

A present invention solar power camera includes: a) a digital camera main housing; b) digital camera internal mechanisms, including imaging and storage processors located within the main housing, imaging and storage controls, and a lens connected to the imaging processor and located on the main housing; c) a rechargeable power storage unit connected to the digital camera internal mechanisms; and, d) at least one solar cell panel connected to the rechargeable power storage unit and movably connected to said main housing, said at least one solar cell panel having a first position, being a closed position, and having a second position, being an open position; wherein the at least one solar cell panel is movable from the first position to the second position for solar recharging of the rechargeable power storage unit, and is movable from the second position to the first position for storage.

In some preferred embodiments of the present invention solar powered camera having at least one solar cell panel, the at least one solar cell panel is hingedly connected to the main housing for flip up movement from the first position to the second position and subsequently from the second position to the first position.

In some preferred embodiments of the present invention solar powered camera having at least one solar cell panel, the at least one solar cell panel is slideably connected to the main housing for sliding movement from the first position to the second position and subsequently from the second position to the first position.

In some preferred embodiments of the present invention solar powered camera having at least one solar cell panel, the at least one solar cell panel is pivotally connected to the main housing so as to allow single plane rotation of the at least one solar cell panel for pivoting rotational movement from the first position to the second position and subsequently from the second position to the first position.

In some preferred embodiments of the present invention solar powered camera having at least one solar cell panel, the at least one solar cell is telescopically connected to the main housing for telescopic movement from the first position to the second position and subsequently from the second position to the first position.

In some preferred embodiments of the present invention solar powered camera having at least one solar cell panel, the at least one solar cell panel is connected to the main housing by a compound movement connection that includes a hinge and a rotational connector connected to said hinge, wherein one of the hinge and the rotational connector is connected to the at least one solar cell panel and the other of the hinge and rotational connector is connected to the main housing such that the at least one solar cell panel is movable via flip up movement along the hinge, and by rotational movement in a different direction along the rotational connector, from the first position to the second position and subsequently from the second position to the first position.

In some preferred embodiments of the present invention solar powered camera having at least one solar cell panel, the at least one solar cell panel is connected to the main housing by a compound movement connection that includes a sliding mechanism and a rotational connector connected to the sliding mechanism, wherein one of the sliding mechanism and the rotational connector is connected to the at least one solar cell panel and the other of the sliding mechanism and rotational connector is connected to the main housing such that the at least one solar cell panel is movable via sliding movement, and by rotational movement in a different direction along the rotational connector, from the first position to the second position and subsequently from the second position to the first position.

In some preferred embodiments of the present invention solar powered camera having at least one solar cell panel, in which the at least one solar cell panel is connected to the main housing by a compound movement connection that includes a sliding mechanism and a rotational connector connected to the sliding mechanism, the sliding mechanism is at least one track and rail.

In some preferred embodiments of the present invention solar powered camera having at least one solar cell panel, the at least one solar cell panel is connected to the main housing by a compound movement connection that includes a pivot point and a rotational connector connected to the pivot point, wherein one of the pivot point and the rotational connector is connected to the at least one solar cell panel and the other of the pivot point and rotational connector is connected to the main housing such that the at least one solar cell panel is movable via pivoting rotational movement, and by rotational movement in a different direction along the rotational connector, from the first position to the second position and subsequently from the second position to the first position.

In some preferred embodiments of the present invention solar powered camera having at least one solar cell panel, the at least one solar cell panel is connected to the main housing by a compound movement connection that includes a telescopic movement mechanism and a rotational connector connected to the telescopic movement mechanism, wherein one of the telescopic movement mechanism and the rotational connector is connected to the at least one solar cell panel and the other of the telescopic movement mechanism and rotational connector is connected to the main housing such that the at least one solar cell panel is movable via telescoping movement, and by rotational movement in a different direction along the rotational connector, from the first position to the second position and subsequently from the second position to the first position.

A present invention solar power camera includes: a) a digital camera main housing; b) digital camera internal mechanisms, including imaging and storage processors located within the main housing, imaging and storage controls, and a lens connected to the imaging processor and located on the main housing; c) a rechargeable power storage unit connected to the digital camera internal mechanisms; and, d) at least two solar cell panels connected to the rechargeable power storage unit, wherein at least one of the at least two solar cell panels is movably connected to the main housing, said at least one solar cell panel having a first position, being a closed position, and having a second position, being an open position; wherein said at least one solar cell panel is movable from the first position to the second position for solar recharging of the rechargeable power storage unit, and is movable from the second position to the first position for storage.

In some preferred embodiments of the present invention solar powered camera having at least two solar cell panels, said at least one solar cell panel is hingedly connected to said main housing for flip up movement from said first position to said second position and subsequently from said second position to said first position.

In some preferred embodiments of the present invention solar powered camera having at least two solar cell panels, the at least one solar cell panel is slideably connected to the main housing for sliding movement from the first position to the second position and subsequently from the second position to the first position.

In some preferred embodiments of the present invention solar powered camera having at least two solar cell panels, the at least one solar cell panel is pivotally connected to the main housing so as to allow single plane rotation of the at least one solar cell panel for pivoting rotational movement from the first position to the second position and subsequently from the second position to the first position.

In some preferred embodiments of the present invention solar powered camera having at least two solar cell panels, the at least one solar cell is telescopically connected to the main housing for telescopic movement from the first position to the second position and subsequently from the second position to the first position.

In some preferred embodiments of the present invention solar powered camera having at least two solar cell panels, the at least one solar cell panel is connected to the main housing by a compound movement connection that includes a hinge and a rotational connector connected to the hinge, wherein one of the hinge and the rotational connector is connected to the at least one solar cell panel and the other of the hinge and rotational connector is connected to the main housing such that the at least one solar cell panel is movable via flip up movement along the hinge, and by rotational movement in a different direction along the rotational connector, from the first position to the second position and subsequently from the second position to the first position.

In some preferred embodiments of the present invention solar powered camera having at least two solar cell panels, the at least one solar cell panel is connected to the main housing by a compound movement connection that includes a sliding mechanism and a rotational connector connected to the sliding mechanism, wherein one of the sliding mechanism and the rotational connector is connected to the at least one solar cell panel and the other of the sliding mechanism and rotational connector is connected to the main housing such that the at least one solar cell panel is movable via sliding movement, and by rotational movement in a different direction along the rotational connector, from the first position to the second position and subsequently from the second position to the first position.

In some preferred embodiments of the present invention solar powered camera having at least two solar cell panels, in which the at least one solar cell panel is connected to the main housing by a compound movement connection that includes a sliding mechanism and a rotational connector connected to the sliding mechanism, the sliding mechanism is at least one track and rail.

In some preferred embodiments of the present invention solar powered camera having at least two solar cell panels, the at least one solar cell panel is connected to the main housing by a compound movement connection that includes a pivot point and a rotational connector connected to the pivot point, wherein one of the pivot point and the rotational connector is connected to the at least one solar cell panel and the other of the pivot point and rotational connector is connected to the main housing such that the at least one solar cell panel is movable via pivoting rotational movement, and by rotational movement in a different direction along the rotational connector, from the first position to the second position and subsequently from the second position to the first position.

In some preferred embodiments of the present invention solar powered camera having at least two solar cell panels, the at least one solar cell panel is connected to the main housing by a compound movement connection that includes a hinge and a rotational connector connected to the hinge, wherein one of the hinge and the rotational connector is connected to the at least one solar cell panel and the other of the hinge and rotational connector is connected to the main housing such that the at least one solar cell panel is movable via flip up movement, and by rotational movement in a different direction along the rotational connector, from the first position to the second position and subsequently from the second position to the first position.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a schematic diagram of an embodiment of a present invention solar powered camera;

FIG. 2 is a rear elevation view of another embodiment of a present invention solar powered camera, in open position;

FIG. 3 is a rear elevation view of the embodiment of the present invention solar powered camera shown in FIG. 2, in closed position;

FIG. 4 is a rear elevation view of another embodiment of a present invention solar powered camera, in open position;

FIG. 5 is a rear elevation view of the embodiment of the present invention solar powered camera shown in FIG. 4, in closed position;

FIG. 6 is a rear elevation view of another embodiment of a present invention solar powered camera, in open position;

FIG. 7 is a rear elevation view of another embodiment of a present invention solar powered camera, in open position;

FIG. 8 is a rear elevation view of another embodiment of a present invention solar powered camera, in open position;

FIG. 9 is a rear elevation view of the embodiment of the present invention solar powered camera shown in FIG. 8, in closed position;

FIG. 10 is a perspective view of another embodiment of the present invention solar powered camera;

FIG. 11 is a perspective view of another embodiment of the present invention solar powered camera in open position;

FIG. 12 is a perspective view of the embodiment of the present invention solar powered camera shown in FIG. 11, in closed position;

FIG. 13 is a perspective view of another embodiment of the present invention solar powered camera, in open position;

FIG. 14 is a perspective view of the embodiment of the present invention solar powered camera shown in FIG. 13, in closed position;

FIG. 15 is a rear elevation view of another embodiment of a present invention solar powered camera, in closed position;

FIG. 16 is a rear elevation view of the embodiment of the present invention solar powered camera shown in FIG. 15;

FIG. 17 is a rear elevation view of the embodiment of the present invention solar powered camera shown in FIG. 15, in open position;

FIG. 18 is a perspective view of another embodiment of the present invention solar powered camera, in open position;

FIG. 19 is a rear elevation view of another embodiment of a present invention solar powered camera, in closed position;

FIG. 20 is a rear elevation view of the embodiment of the present invention solar powered camera shown in FIG. 19;

FIG. 21 is a rear elevation view of the embodiment of the present invention solar powered camera shown in FIG. 19;

FIG. 22 is a rear elevation view of the embodiment of the present invention solar powered camera shown in FIG. 19;

FIG. 23 is a rear elevation view of another embodiment of a present invention solar powered camera;

FIG. 24 is a rear elevation view of another embodiment of a present invention solar powered camera, in closed position;

FIG. 25 is a rear elevation view of the embodiment of the present invention solar powered camera shown in FIG. 24;

FIG. 26 is a perspective view of the embodiment of the present invention solar powered camera shown in FIG. 24;

FIG. 27 is a perspective view of the embodiment of the present invention solar powered camera shown in FIG. 24;

FIG. 28 is a perspective view of the embodiment of the present invention solar powered camera shown in FIG. 24;

FIG. 29 is a rear elevation view of another embodiment of a present invention solar powered camera, in closed position;

FIG. 30 is a rear elevation view of the embodiment of the present invention solar powered camera shown in FIG. 29;

FIG. 31 is a rear elevation view of the embodiment of the present invention solar powered camera shown in FIG. 29;

FIG. 32 is a perspective view of the embodiment of the present invention solar powered camera shown in FIG. 29;

FIG. 33 is a rear elevation view of another embodiment of a present invention solar powered camera, in closed position;

FIG. 34 is a rear elevation view of the embodiment of the present invention solar powered camera shown in FIG. 33;

FIG. 35 is a rear elevation view of the embodiment of the present invention solar powered camera shown in FIG. 33;

FIG. 36 is a perspective view of the embodiment of the present invention solar powered camera shown in FIG. 33;

FIG. 37 is a rear elevation view of another embodiment of a present invention solar powered camera, in closed position;

FIG. 38 is a rear elevation view of the embodiment of the present invention solar powered camera shown in FIG. 37;

FIG. 39 is a perspective view of the embodiment of the present invention solar powered camera shown in FIG. 37;

FIG. 40 is a rear elevation view of another embodiment of the present invention solar powered camera, in open position;

FIG. 41 is a rear elevation view of another embodiment of the present invention solar powered camera, in open position;

FIG. 42 is a rear elevation view of another embodiment of the present invention solar powered camera, in open position; and

FIG. 43 is a rear elevation view of another embodiment of the present invention solar powered camera, in open position.

### DETAILED DESCRIPTION OF THE EMBODIMENTS

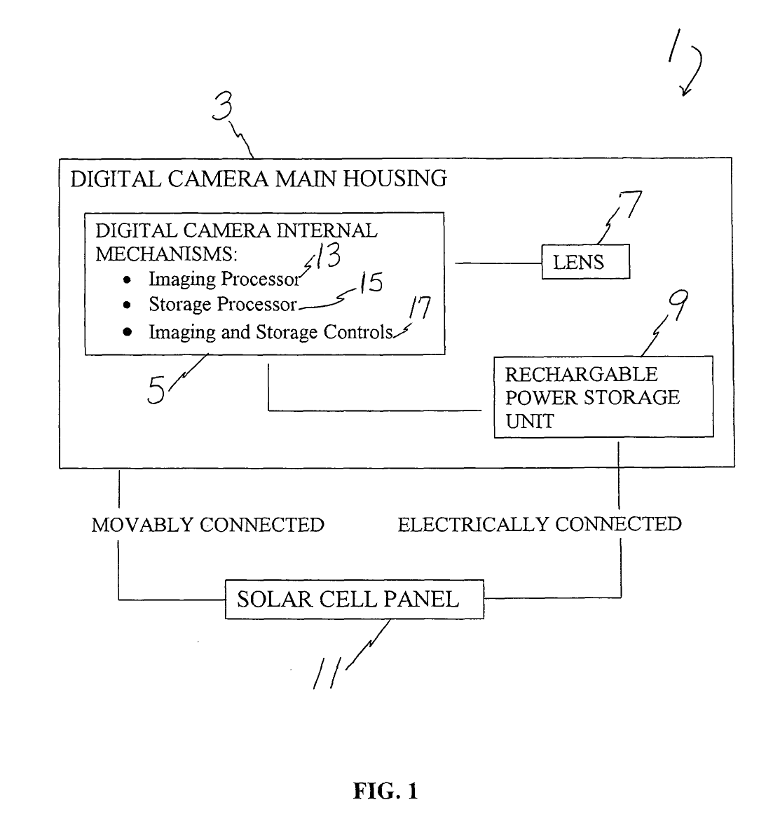

Referring now in detail to the drawings wherein like reference numerals designate corresponding parts throughout the several views, various embodiments of the present invention are shown. FIG. 1 is a schematic diagram of an embodiment of a present invention solar powered camera;

A solar powered camera 1 includes a digital camera main housing 3. The digital camera main housing 3 contains digital camera internal mechanisms 5, a lens 7, and a rechargeable power storage unit 9. In some preferred embodiments, the rechargeable power storage unit 9 is one or more batteries (not shown), while in other embodiments, the rechargeable power storage unit 9 is a capacitor, a flywheel, or another form of power storage unit. At least one solar panel 11 is movably connected to the digital camera main housing 3 and is electrically connected to the rechargeable power storage unit 9. The digital camera internal mechanisms 5 include an imaging processor 13, a storage processor 15, and imaging and storage controls 17. The imaging processor 13 takes light from the lens and converts it into a digital image. The storage processor 15 receives and stores the digital image from the imaging processor 13. Imaging and storage controls 17 allow a user to manipulate the imaging processor 13 and the storage processor 15 to take photographs, to store them, and to retrieve them later.

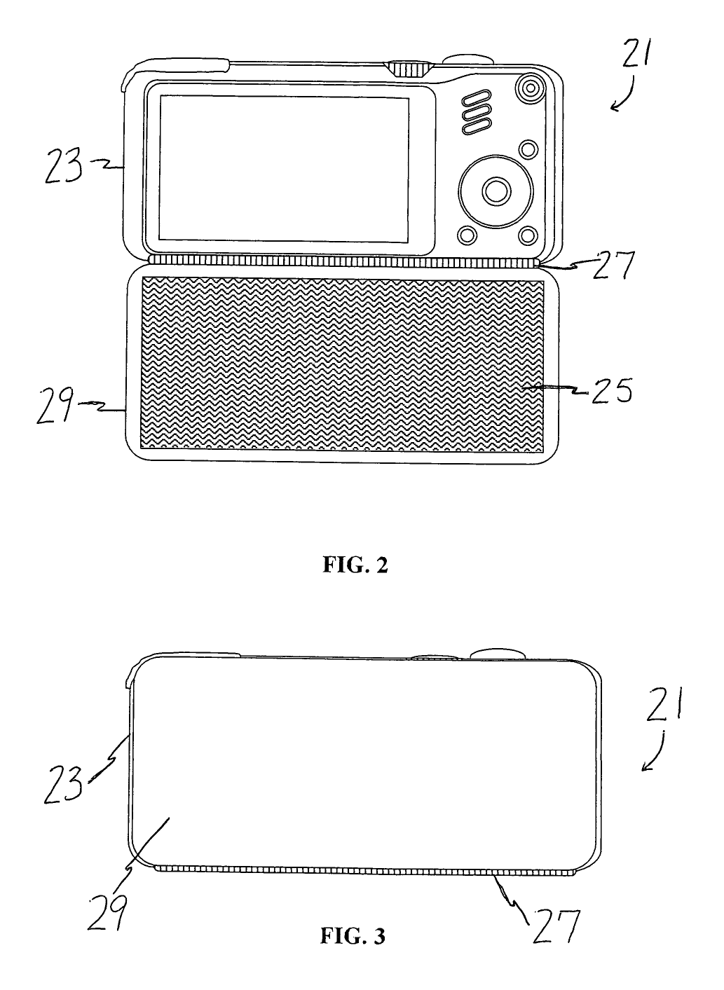

Turning now to FIGS. 2 and 3, another embodiment of the present invention solar powered camera is shown. A solar powered camera 21 includes a digital camera main housing 23. Although the digital camera main housing 23 as shown in FIGS. 2 and 3 contains various buttons and dials, the buttons and dials are for illustrative purposes only and are not meant to limit the scope of the present invention to any one style of camera. This is similarly true for all buttons and dials shown on the digital camera main housing in other Figures as well. Likewise, FIG. 2 shows a screen on the rear face of the camera, as do many of the other Figures; although many digital cameras have such a screen, the inclusion of a screen here is for illustrative purposes only, and the invention is not limited to cameras having a rear screen. At least one solar panel 25 is movably connected to the digital camera main housing 23 by a hinge 27. The hinge 27 is preferably a ratcheting hinge that allows the at least one solar panel 25 to be positioned at any number of pre-determined angles to maximize sun exposure. Throughout the claims, solar panels that are hingedly connected are described as moving via “flip up movement.” The phrase “flip up movement” means a movement around a hinge from a closed first position to an open second position. In this context, the word “flip” does not mean that the panel must turn completely over, but merely that one edge of the panel is hingedly connected. The word “up” means toward the open second position. In this context, “up” has no relation to the direction of gravity; “flip up movement” is judged relative to the rest of the camera.

FIG. 3 shows the at least one solar panel 25 in closed position. In the embodiment shown in FIGS. 2 and 3, the at least one solar panel 25 has a protective backing 29. This protective backing 29 helps protect the at least one solar panel 25 from damage when the at least one solar panel is in the closed position.

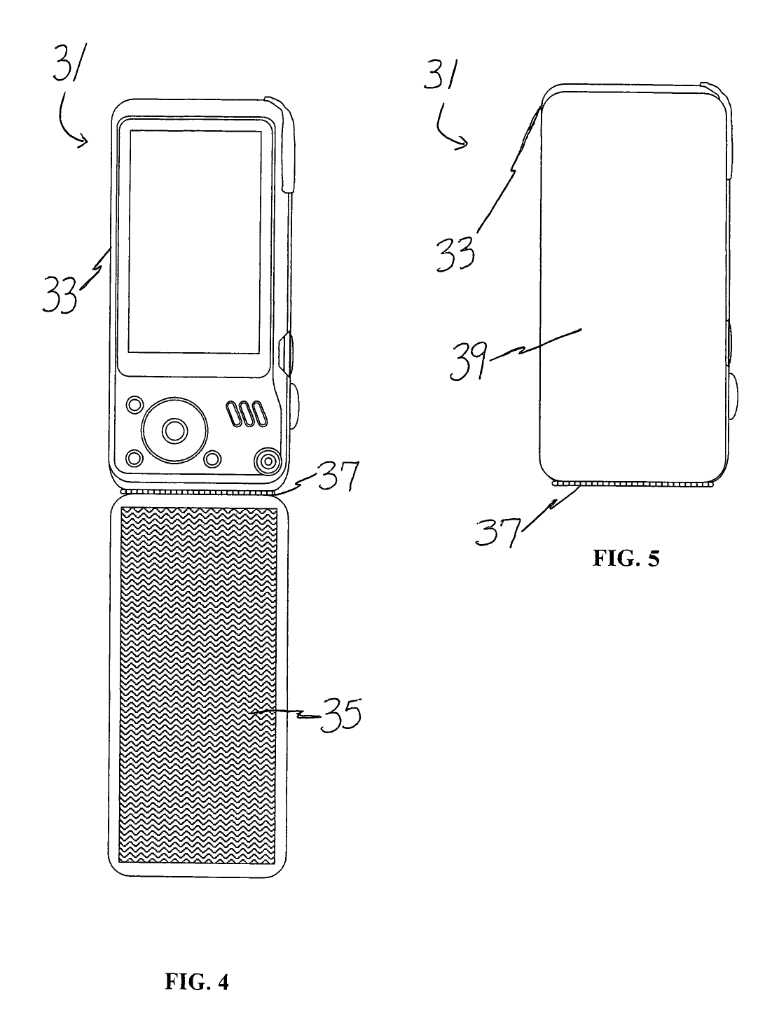

Turning now to FIGS. 4 and 5, another embodiment of the present invention solar powered camera is shown. A solar powered camera 31 includes a digital camera main housing 33. At least one solar panel 35 is movably connected to the digital camera main housing 33 by a hinge 37. In the embodiment shown in FIGS. 4 and 5, the at least one hinge 37 is connected to the digital camera main housing 33 along the back right side edge when viewed from the back, while in the embodiment shown in FIGS. 2 and 3, the at least one hinge 27 is connected to the digital camera main housing 23 along the back bottom edge. This illustrates that the hinge 37 can be placed along any edge of the digital camera main housing 33, although to maximize solar panel surface area, it may be desirable to place the hinge 37 such that the at least one solar panel 35 covers the front of the camera or the back when in the closed position. The hinge 37 is preferably a ratcheting hinge that allows the at least one solar panel 35 to be positioned at any number of pre-determined angles to maximize sun exposure.

FIG. 5 shows the at least one solar panel 35 in closed position. In the embodiment shown in FIGS. 4 and 5, the at least one solar panel 35 has a protective backing 39. This protective backing 39 helps protect the at least one solar panel 35 from damage when the at least one solar panel 35 is in the closed position.

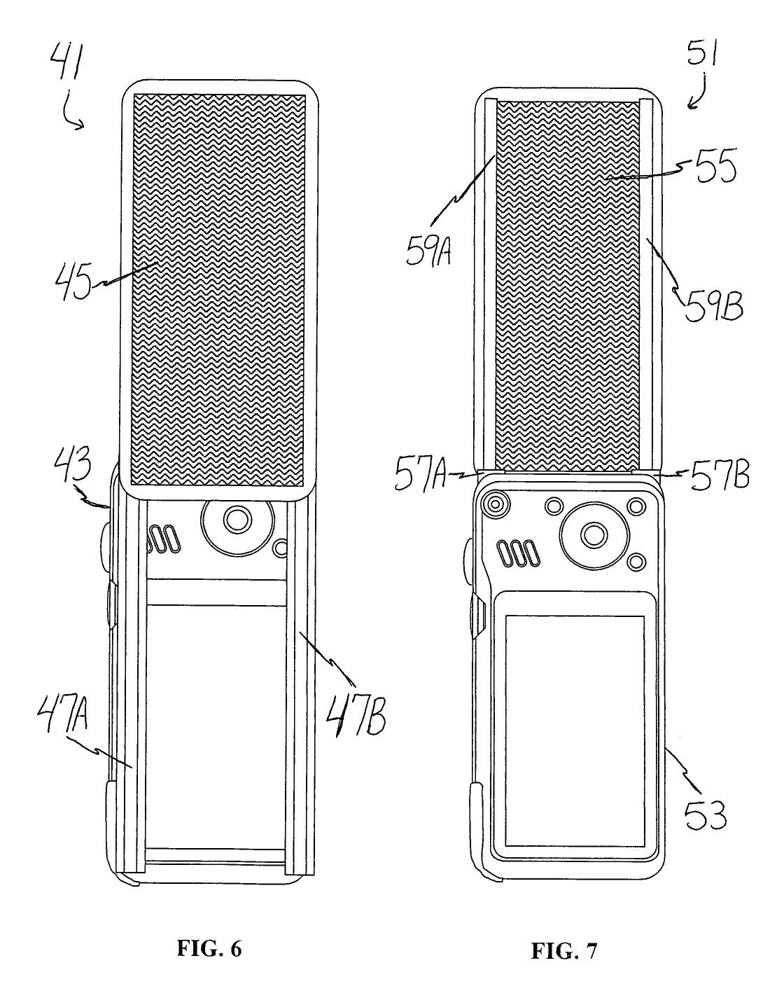

Turning now to FIG. 6, another embodiment of the present invention solar powered camera is shown. A solar powered camera 41 includes a digital camera main housing 43. At least one solar panel 45 is movably connected to the digital camera main housing 43 by at least one sliding movement mechanism. In the embodiment shown in FIG. 6, the sliding movement mechanism is a pair of tracks 47A and 47B affixed to the back of the digital camera main housing 43, which are fitted with a pair of rails (not shown) affixed to the underside of the at least one solar panel 45. The sliding movement mechanism allows the at least one solar panel 45 to slide. The track and rail system shown in FIG. 6 shows two tracks 47A and 47B, but some embodiments of the present invention having a track-and-rail sliding movement mechanism will have just a single track and rail, while others will have a plurality of tracks with a plurality of rails, each of which is seated within one of the plurality of tracks. Other sliding movement mechanisms may involve shaping the digital camera main housing 43 in such a way that the solar panel itself can slide from a closed position to an open position, but cannot be detached from the digital camera main housing. The tracks 47A and 47B and rails (not shown) may be integrated into the main housing 43 and the solar panel 45, or they may be attachable components. Also, although FIG. 6 shows the tracks attached to the main housing 43, the tracks may be alternatively attached to the solar panel 45 and the rails may be attached to the main housing 43.

Unlike the embodiments shown in FIGS. 2 through 5, at least one solar panel 45 shown in FIG. 6 is movably attached to the digital camera main housing 43 such that the light-receiving surface of the at least one solar panel 45 is always facing away from the digital camera main housing 43. Although this exposes the light-receiving surface to potential damage, the embodiment shown in FIG. 6 does have the advantage of being able to generate solar energy even when in the closed position. Another advantage of this embodiment is that if a track and rail system is used for the sliding movement mechanism, the at least one rail (not shown) which is affixed to the underside of the at least one solar panel 45, will not have to be affixed to the light-receiving side of the at least one solar panel.

Turning now to FIG. 7, another embodiment of the present invention solar powered camera is shown. A solar powered camera 51 includes a digital camera main housing 53. At least one solar panel 55 is movably connected to the digital camera main housing 53 by at least one sliding movement mechanism. In the embodiment shown in FIG. 7, the sliding movement mechanism is a pair of tracks 57A and 57B affixed to the front side of the digital camera main housing. The pair of tracks 57A and 57B are fitted with a pair of rails 59A and 59B affixed to the light-receiving side of the at least one solar panel 55. This embodiment of the present invention solar powered camera has the advantage of protecting the light-receiving side of the solar panel 55. The sliding movement mechanism allows the at least one solar panel 55 to slide. The track and rail system shown in FIG. 7 shows two tracks 47A and 47B, but some embodiments of the present invention having a track-and-rail sliding movement mechanism will have just a single track and rail, while others will have a plurality of tracks with a plurality of rails, each of the rails seated within one of the plurality of tracks. Other sliding movement mechanisms may involve shaping the digital camera main housing 53 in such a way to define tracks in which the solar panel itself can slide from a closed position to an open position, but cannot be detached from the digital camera main housing. The tracks 57A and 57B and rails 59A and 59B may be integrated into the main housing 43 and the solar panel 45, or they may be attachable components. Also, although FIG. 6 shows the tracks attached to the main housing 53 and the rails attached to the solar panel 55, the tracks may be alternatively attached to the solar panel 55 and the rails may be attached to the main housing 53.

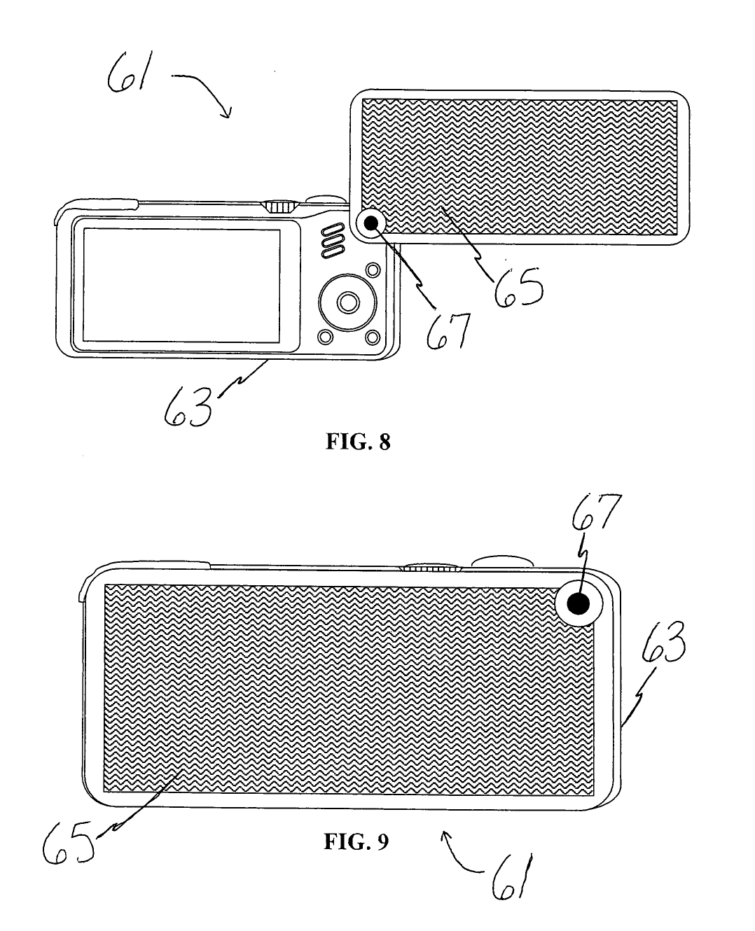

Turning now to FIGS. 8 and 9, another embodiment of the present invention solar powered camera is shown. A solar powered camera 61 includes a digital camera main housing 63. At least one solar panel 65 is pivotally connected to the digital camera main housing 63 by at least one rotational connector 67. The rotational connector 67 allows the at least one solar panel 65 to pivot in a single plane of rotation from a closed position to an open position and back to a closed position. The solar powered camera 61 is shown in the open position in FIG. 8 and in the closed position in FIG. 9. In some embodiments of the present invention solar powered camera having a rotational connector 67, the at least one solar panel 65 can freely rotate around the rotational connector 67, allowing the at least one solar panel 65 to be moved from the open position shown in FIG. 8 to the closed position shown in FIG. 9 by either clockwise rotation or by counterclockwise rotation. In other embodiments of the present invention solar powered camera, the at least one solar panel 65 rotates only within a limited range of motion. In the embodiment shown is FIGS. 8 and 9, the at least one solar panel 65 is attached to the digital camera main housing 63 such that the light-receiving side of the at least one solar panel 65 is exposed when the at least one solar panel 65 is in the closed position shown in FIG. 9. Although this exposes the light-receiving surface to potential damage, the embodiment shown in FIGS. 8 and 9 does have the advantage of being able to generate solar energy even when in the closed position.

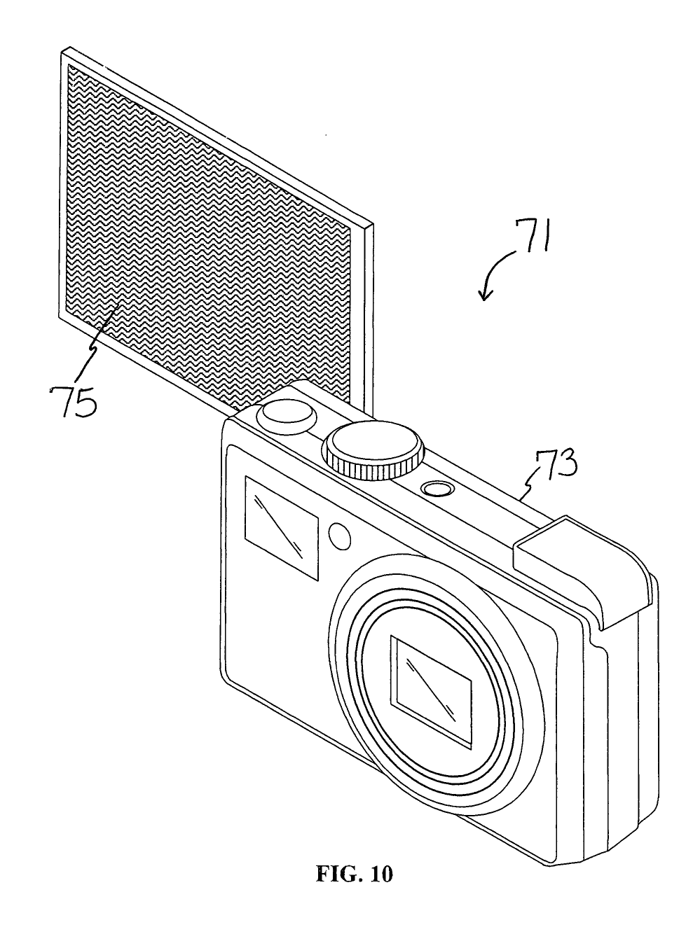

Turning now to FIG. 10, another embodiment of the present invention solar powered camera is shown. A solar powered camera 71 includes a digital camera main housing 73, and at least one solar panel 75 pivotally attached to the digital camera main housing 73 by a rotational connector (not shown). As shown in FIG. 10, a light receiving side of the at least one solar panel 75 faces the digital camera housing 73, such that when the at least one solar panel 75 is in the closed position, the light receiving side of the at least one solar panel 75 is hidden. In some embodiments of the present invention solar powered camera, the reverse side of the at least one solar panel 75 is a protective backing (not shown) to protect the at least one solar panel 75 when the at least one solar panel 75 is in the closed position. In other embodiments of the present invention solar powered camera, the reverse side of the at least one solar panel 75 is another light-receiving side; in other words, the at least one solar panel 75 receives light on both sides when the at least one solar panel 75 is in the open position.

It is important to note that although the digital camera main housing 73 has various camera features shown (e.g. flash bulb, lens cover, finger rest, buttons, etc.), the design of the camera is not material to the invention. This is also true of the camera features shown on the back of the camera in rear elevation views such as FIG. 2. The camera features shown in FIG. 10 and elsewhere in the drawings are for illustrative purposes only and are not intended to limit the scope of the invention to any particular design of camera. Camera features shown in the drawings may be modified or removed without negating the patentability of the invention.

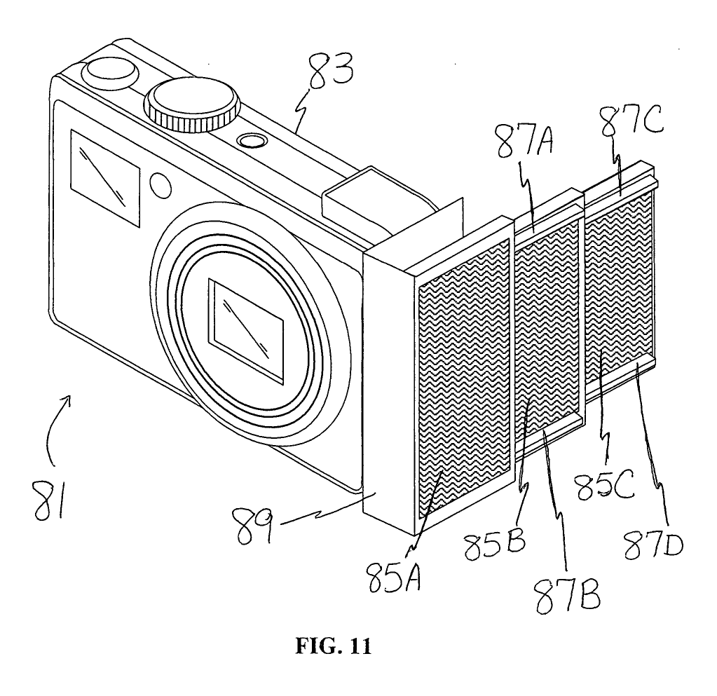

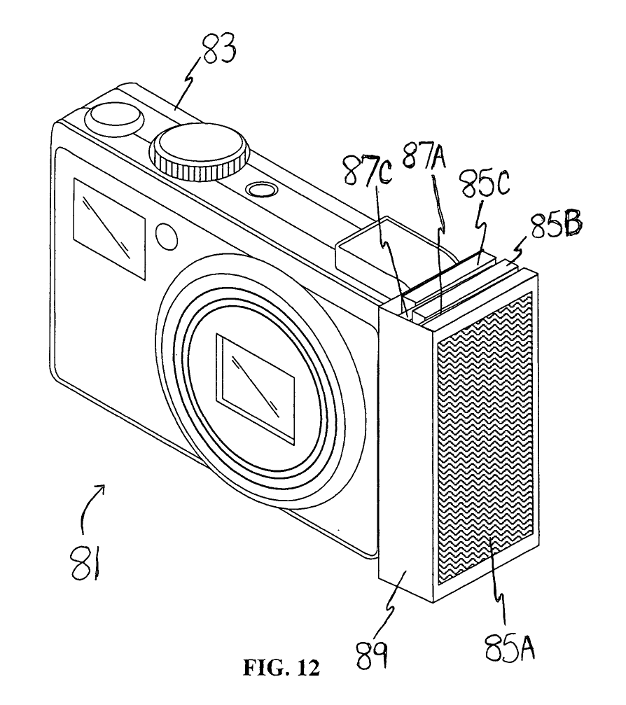

Turning now to FIGS. 11 and 12, another embodiment of the present invention solar powered camera is shown. A solar powered camera 81 includes a digital camera main housing 83. At least one solar panel 85A is connected to the digital camera main housing 83 via a solar panel housing 89. Solar panel 85A is connected to solar panel 85B by a track and rail system that includes rail 87A and rail 87B. Rail 87A and rail 87B each movably slide within respective tracks (not shown) attached to solar panel 85A. Solar panel 85B is connected to solar panel 85C by a track and rail system that includes rail 87C and rail 87D. Rail 87C and rail 87D each movably slide within respective tracks (not shown) attached to solar panel 85B. Also shown is solar panel housing 89, which is attached to the digital camera main housing 83, adapted to receive solar panel 85B and solar panel 85C when the solar powered camera 81 is in the closed position. As shown in FIGS. 11 and 12, solar panel 85A is immovably attached to solar panel housing 89. However, in other embodiments, solar panel 85A is movably attached to the solar panel housing.

In the embodiment shown in FIGS. 11 and 12, solar panel 85B and solar panel 85C are protected when in the closed position by solar panel housing 89, but the light-receiving surface of solar panel 85A is exposed in the closed position. Solar panel 85A can continue to collect light in the closed position, but the embodiment shown in FIG. 12 is not ideal for solar collection because the side of the digital camera main housing is smaller than the front or the back of the camera. In order to maximize solar collection, it is preferable to have the maximum possible amount of light-receiving surface exposed to the sun. It is possible that on some camera designs, such as hand-held camcorders, a side of the digital camera main housing will have a larger surface area than the front, back, top, or bottom, in which case this would be the side to use to maximize the light-receiving surface area. One advantage of the embodiment shown in FIGS. 11 and 12 is that if solar panels 85A, 85B, and 85C are attached to a side of the camera, solar panels 85A, 85B, and 85C are less likely to interfere with the normal operation of the camera, whether solar panels 85A, 85B, and 85C are in the open position or the closed position.

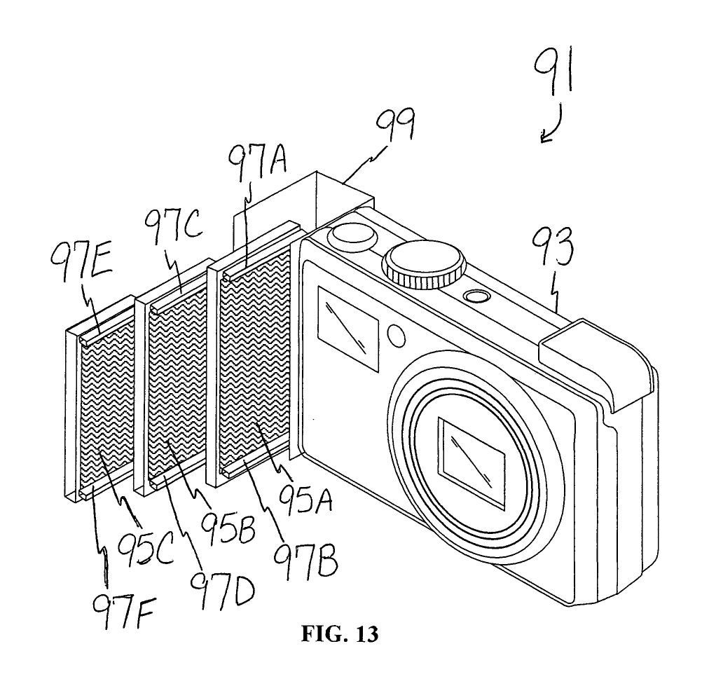

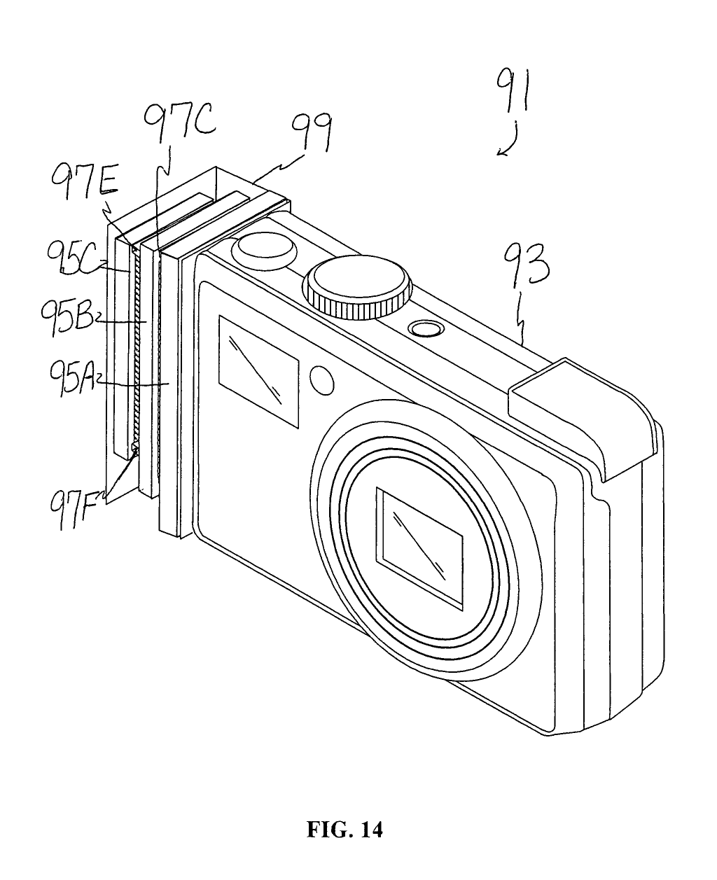

Turning now to the embodiment shown in FIGS. 13 and 14, another embodiment of the present invention solar powered camera is shown. A solar powered camera 91 includes a digital camera main housing 93. At least one solar panel 95A is connected to the digital camera main housing 93 via a solar panel housing 99. Solar panel 95C is connected to solar panel 95B by a track and rail system that includes rail 97E and rail 97F. Rail 97E and rail 97F each movably slide within respective tracks (not shown) attached to solar panel 95B. Solar panel 95B is connected to solar panel 95A by a track and rail system that includes rail 97C and rail 97D. Rail 97C and rail 97D each movably slide within respective tracks (not shown) attached to solar panel 95A. Also shown is solar panel housing 99, which is attached to the digital camera main housing 93. Solar panel 95A is connected to the solar panel housing 99 by a track and rail system that includes rail 97A and rail 97B. Rail 97A and rail 97B each movably slide within respective tracks (not shown) attached to solar panel housing 99. Solar panel housing 99 is adapted to receive solar panel 95A, solar panel 95B, and solar panel 95C when the solar powered camera 91 is in the closed position. In the embodiment shown in FIGS. 13 and 14, solar panel 95A is slideably attached to solar panel housing 99. In the embodiment shown in FIGS. 13 and 14, the light-emitting surface of each of the solar panels 95A, 95B, and 95C, is protected when the solar powered camera 91 is in the closed position. One advantage of the embodiment shown in FIGS. 13 and 14 is that if solar panels 95A, 95B, and 95C are attached to a side of the camera, solar panels 95A, 95B, and 95C are less likely to interfere with the normal operation of the camera, whether solar panels 95A, 95B, and 95C are in the open position or the closed position.

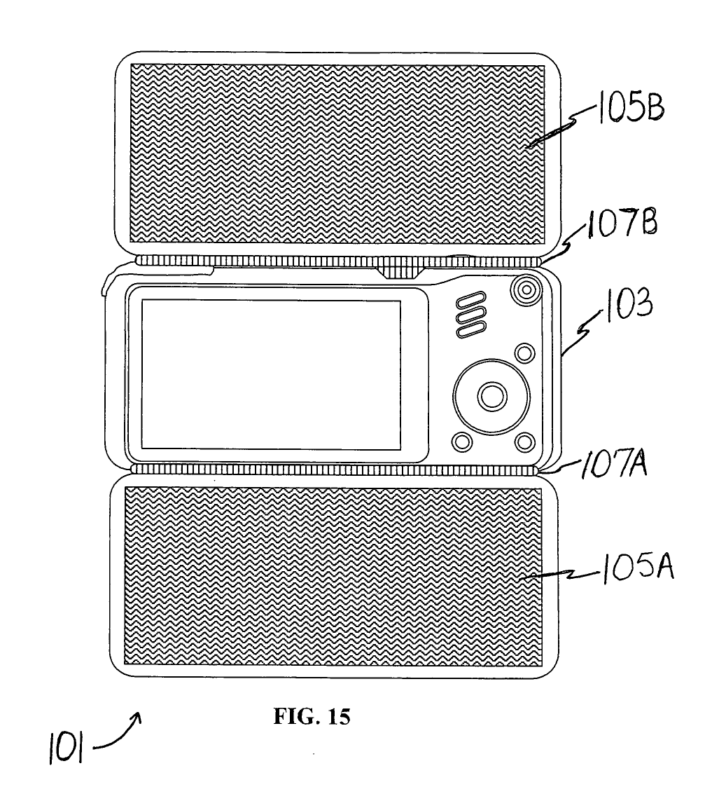

FIGS. 15 through 17 show another embodiment of the present invention solar powered camera. A solar powered camera 101 includes a digital camera main housing 103, a first solar panel 105A connected to the digital camera main housing 103 via a first hinge 107A, and a second solar panel 105B connected to the digital camera main housing 103 via a second hinge 107B. Although two solar panels are pictured, other embodiments of the present invention solar powered camera have more than two solar panels hingedly attached to the digital camera main housing 103. In FIG. 15, the solar powered camera 101 is shown in the open position, with the light-receiving surfaces of solar panel 105A and solar panel 105B exposed.

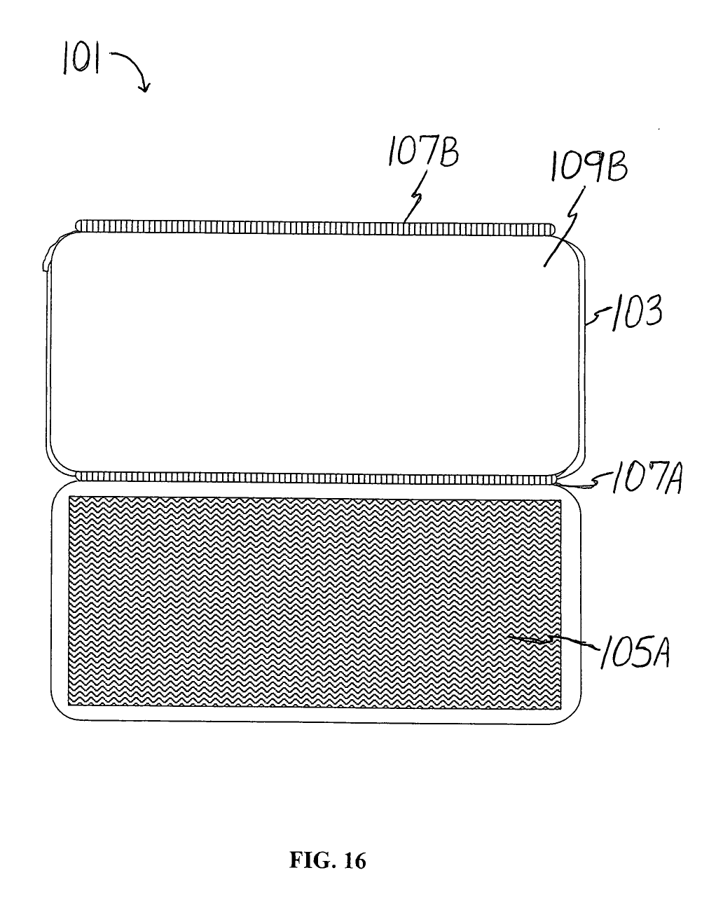

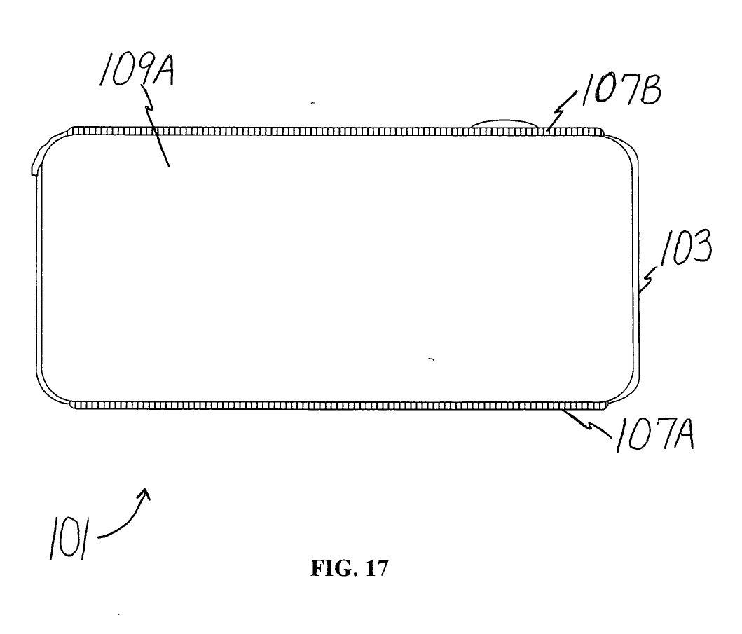

FIG. 16 shows the solar powered camera 101 in a position between the open position and the close position. In FIG. 16, solar panel 105B has been flipped closed, displaying a protective back cover 109B. The light-receiving area of solar panel 105A is still exposed. In FIG. 17, solar panel 105A has also been flipped closed, displaying a protective back cover 109A. The solar panels 105A and 105B would likely be in the protected positions shown in FIG. 17 when the solar powered camera 101 is transported.

The hinges 107A and 107B shown in FIGS. 15 through 17 are preferably ratcheting hinges that allow solar panel 105A and solar panel 105B to be set at a plurality of positions allowed by the range of motion of the ratcheting hinge. The ratcheting mechanisms in hinge 107A and hinge 107B are at least strong enough to support the weight of solar panel 105A and solar panel 105B, respectively, without moving, but in preferred embodiments, these hinges are also strong enough to support the weight of the digital camera main housing or to support solar panel 105A and solar panel 105B in a moderate wind.

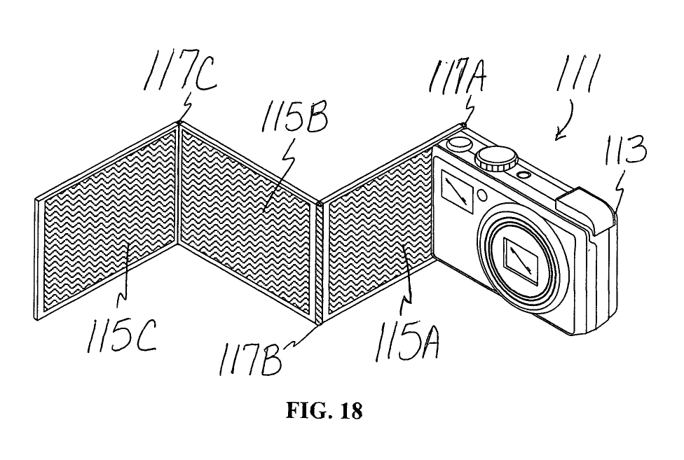

Turning now to FIG. 18, another embodiment of the present invention solar powered camera is shown. In this embodiment, three solar panels 115A, 115B, and 115C, are shown, although in other embodiments two panels could be used, or more than three panels could be used. In the embodiment shown in FIG. 18, a solar powered camera 111 has a digital camera main body 113. A first solar panel 115A is connected to the digital camera main body 113 via a hinge 117A. This hinge is preferably a ratcheting hinge that allows the solar panel 117A to be set at any number of pre-determined angles to maximize sun exposure. A second solar panel 115B is connected to the first solar panel 115A via a hinge 117B. A third solar panel 115C is connected to the second solar panel 115B via a hinge 117C. As with hinge 117A, hinge 117B and hinge 117C are preferably ratcheting hinges that allow the solar panel 117B and the solar panel 117C to be set at any number of pre-determined angles to maximize sun exposure. Preferably, each of the hinges 117A, 117B, and 117C has sufficient range of motion to allow the solar panels 115A, 115B, and 115C to be in a stack when in the closed position and to be in a linear array when in the open position.

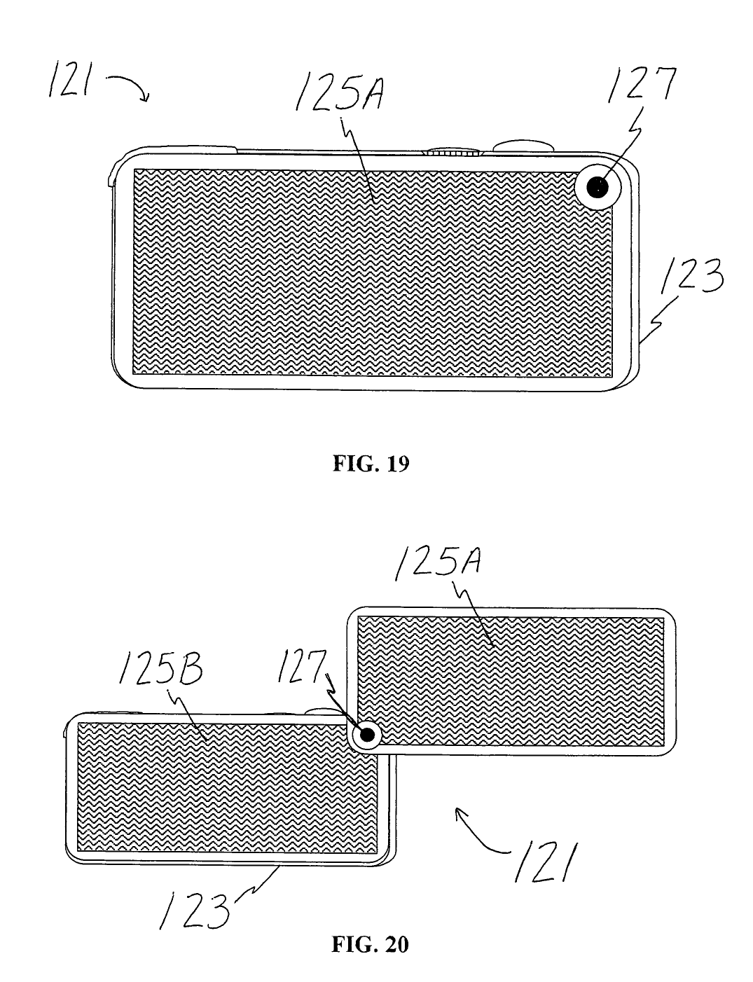

Turning now to FIGS. 19 through 22, another embodiment of the present invention solar powered camera is shown. A solar powered camera 121 includes a digital camera main housing 123. In the embodiment shown in FIGS. 19 through 22, a plurality of solar panels 125 are pivotally connected to the digital camera main housing 123 via a pivot point 127. Each of the solar panels 125 is electrically connected to a rechargeable power storage unit (not shown) within the digital camera main housing 123.

In the embodiment shown in FIGS. 19 through 22, four solar panels 125A, 125B, 125C, and 125D are shown. Other embodiments have more than four solar panels attached to the digital camera main housing 123. There is no set limit to the number of solar panels that can be connected to the digital camera main housing 123.

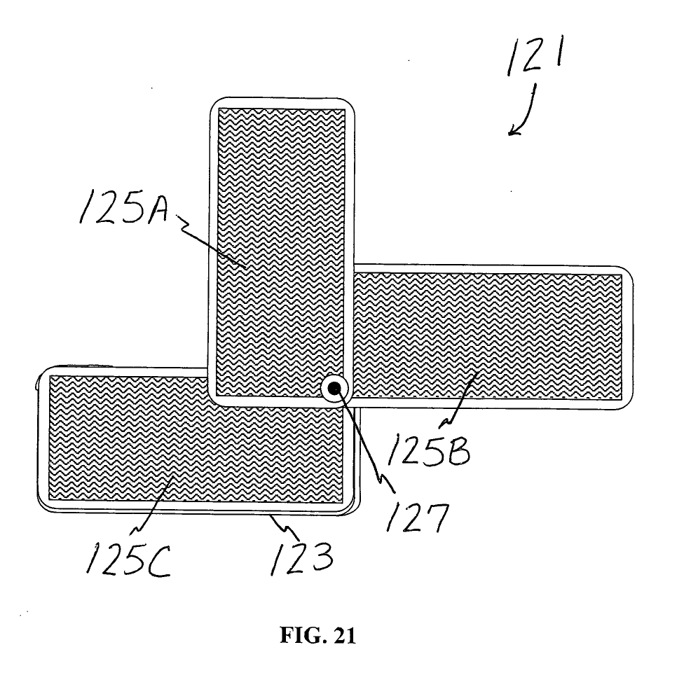

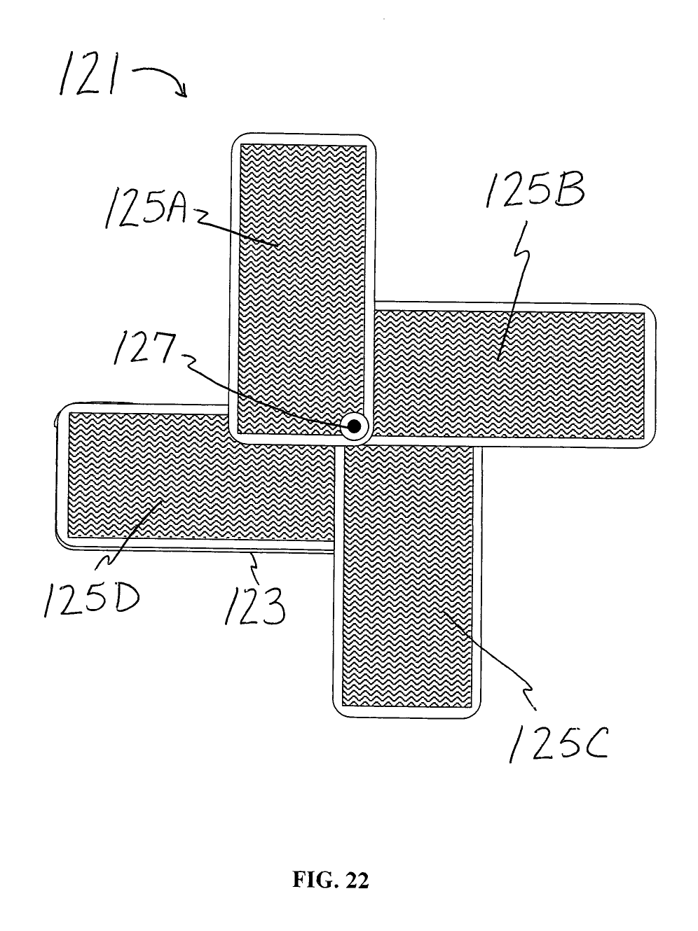

The embodiment shown in FIG. 19 is shown in the closed position. Only solar panel 125A is visible. In this embodiment, the light-receiving surface of solar panel 125A is exposed when solar panel 125A is in the closed position. When solar panel 125A is moved, as in FIG. 20, solar panel 125B is exposed. Likewise, when solar panel 125B is moved, as in FIG. 21, solar panel 125C is exposed. Similarly, when solar panel 125C is moved, as in FIG. 22, solar panel 125D is exposed. In some embodiments, solar panel 125D can also be pivotally moved around pivot point 127 to allow a user to use the functions found on the back of the camera. In other embodiments, solar panel 125D is fixed in place, but no functions are found on the back of the camera. Rather than a back screen, the camera 121 could include a viewfinder (not shown) on top of the camera, and the buttons on the back of the camera could be relocated. Reference to FIGS. 19 through 22 shows that the fully open configuration of FIG. 22 has the greatest surface area and therefore is best for converting light energy into electricity.

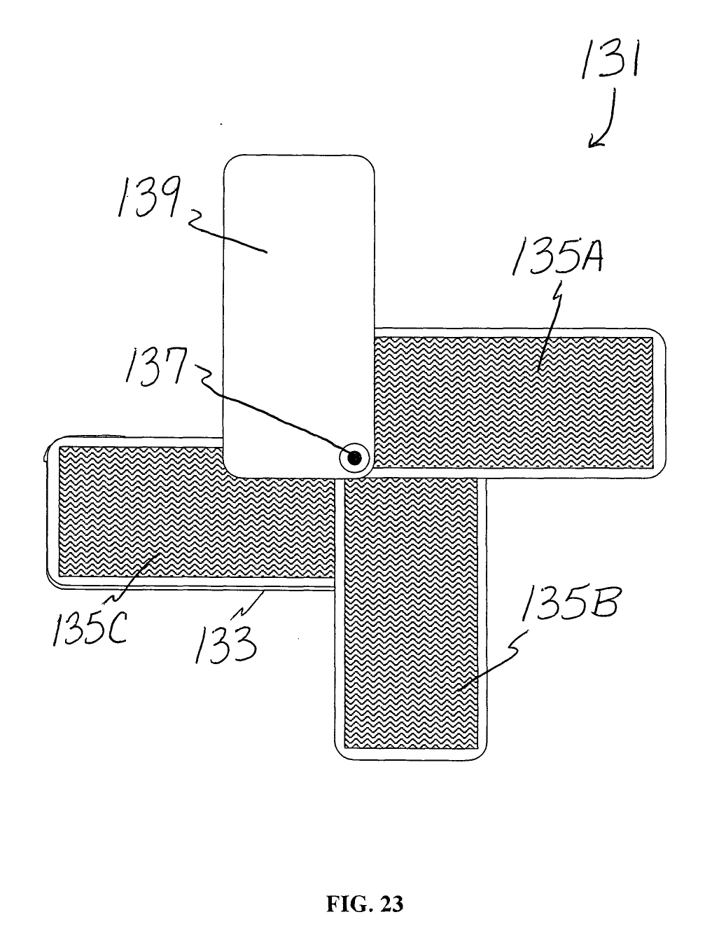

Turning now to FIG. 23, another embodiment of the present invention solar powered camera is shown. A solar powered camera 131 includes a digital camera main housing 133, a first solar panel 135A, a second solar panel 135B, a third solar panel 135C. Solar panels 135A, 135B, and 135C are pivotally connected to the digital camera main housing 133 by a pivot point 137. The pivot point 137 also provides an electrical connection between the solar panels 135A, 135B, and 135C and the rechargeable power storage unit (not shown) found within the digital camera main housing 133. The embodiment shown in FIG. 23 is displayed in the open position. In the closed position, the solar panels 135A, 135B, and 135C are protected by solar panel cover 139. In some embodiments having camera functionality on the back of digital camera housing 133, solar panel 135C can be moved to allow a user access to the camera functionality. In other embodiments, solar panel 135C is fixed, but camera functionality that might be found on the back of the digital camera housing 133 is relocated elsewhere in the digital camera housing 133.

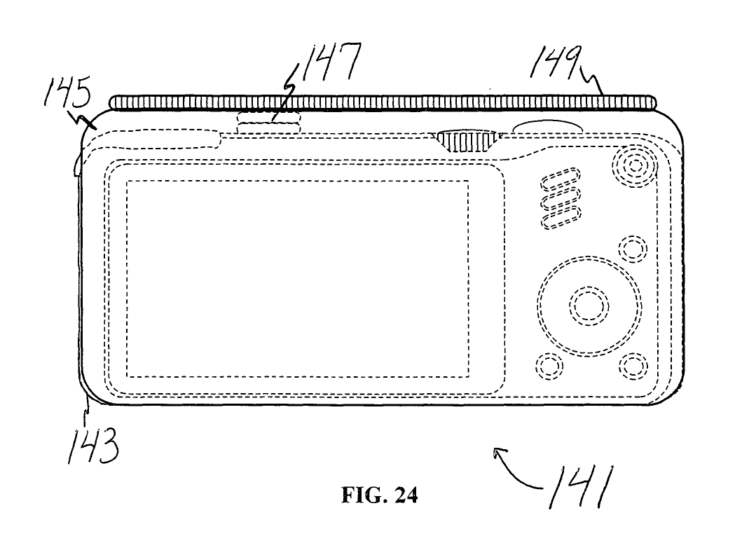

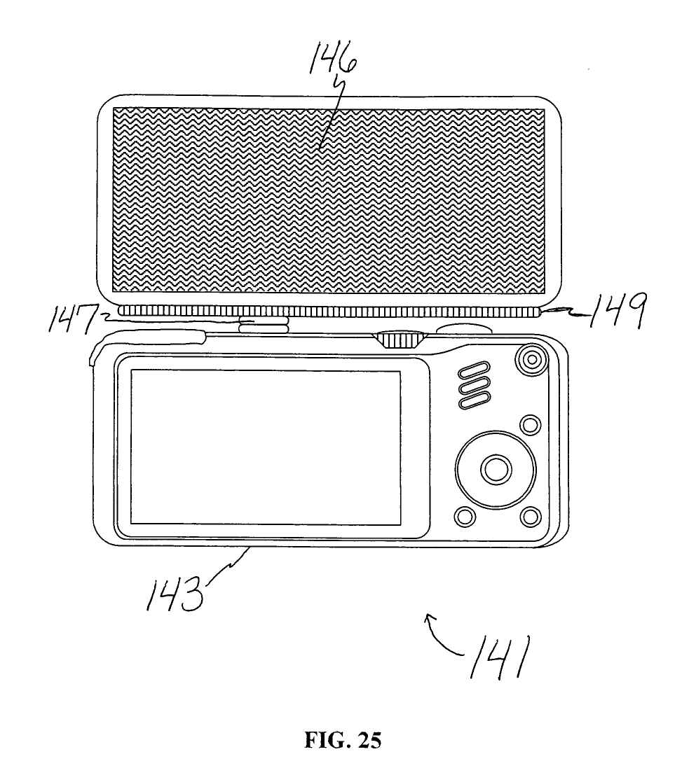

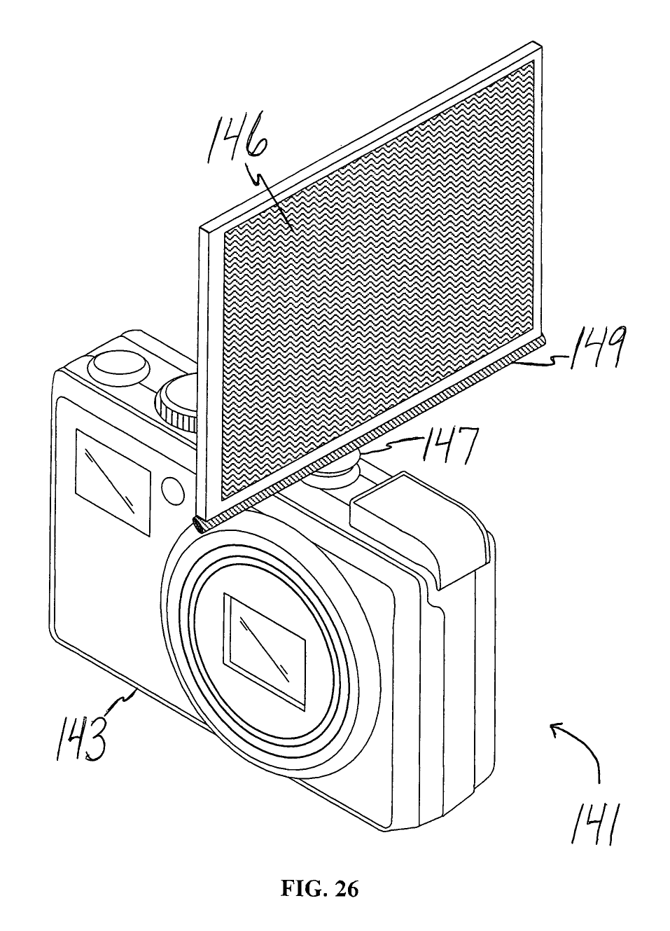

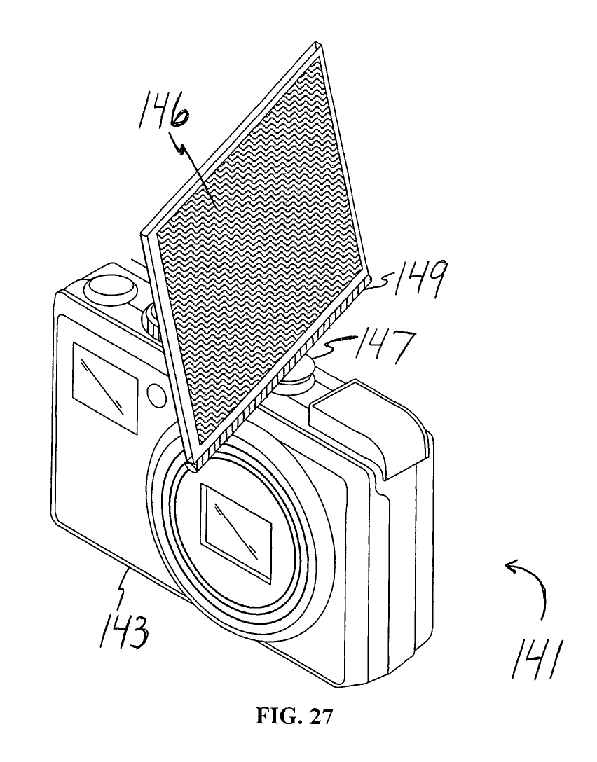

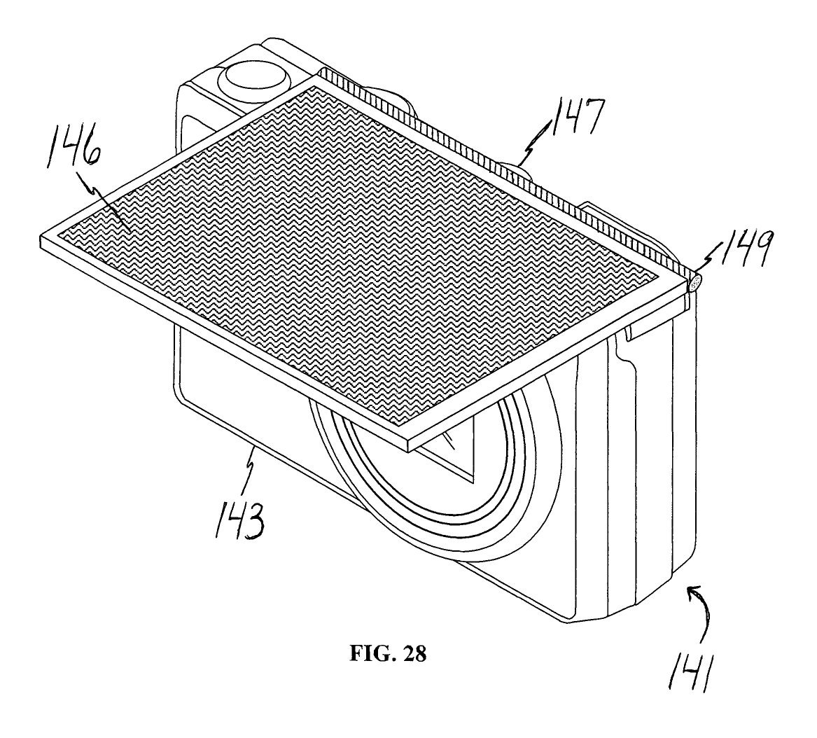

Turning now to FIGS. 24 through 28, another embodiment of a present invention solar powered camera is shown. In this embodiment, a solar powered camera 141 includes a digital camera main housing 143. In FIG. 24, the at least one solar panel (not shown) is in the closed position and is not visible; the protective casing 145 is shown as covering the back of the camera. As shown in FIG. 25, in this embodiment, solar panel 146 is movably attached to the digital camera main housing 143 by two connection mechanisms: a rotational movement mechanism 147 and a hinge 149. In some preferred embodiments, the hinge 149 is a ratcheting hinge that allows the solar panel 146 to be set at any number of pre-determined angles to maximize sun exposure. The rotational movement mechanism 147 allows the solar panel 146 to be adjusted in a different way than would be possible with only the hinge 149. Like the hinge 149, the rotational movement mechanism 147 may, in some preferred embodiments, be a ratcheting rotational movement mechanism that allows the solar panel 146 to be set at any number of predetermined angles. In some alternative embodiments, the rotational movement mechanism 147 may have sufficient friction to prevent unwanted rotational movement while allowing a user to rotate the rotational movement mechanism 147 by hand. In the embodiment pictured in FIGS. 24 through 28, the solar panel 146 is connected to the hinge 149, which is connected to the rotational movement mechanism 147, which is connected to the digital camera main housing 143. However, in other embodiments the solar panel 146 is connected to the rotational movement mechanism, which is connected to the hinge 149, which is then connected to the digital camera main housing 143. As seen in FIG. 28, in some preferred embodiments, the hinge 149 is flexible enough to allow the solar panel 146 to face straight toward the sky in the open position.

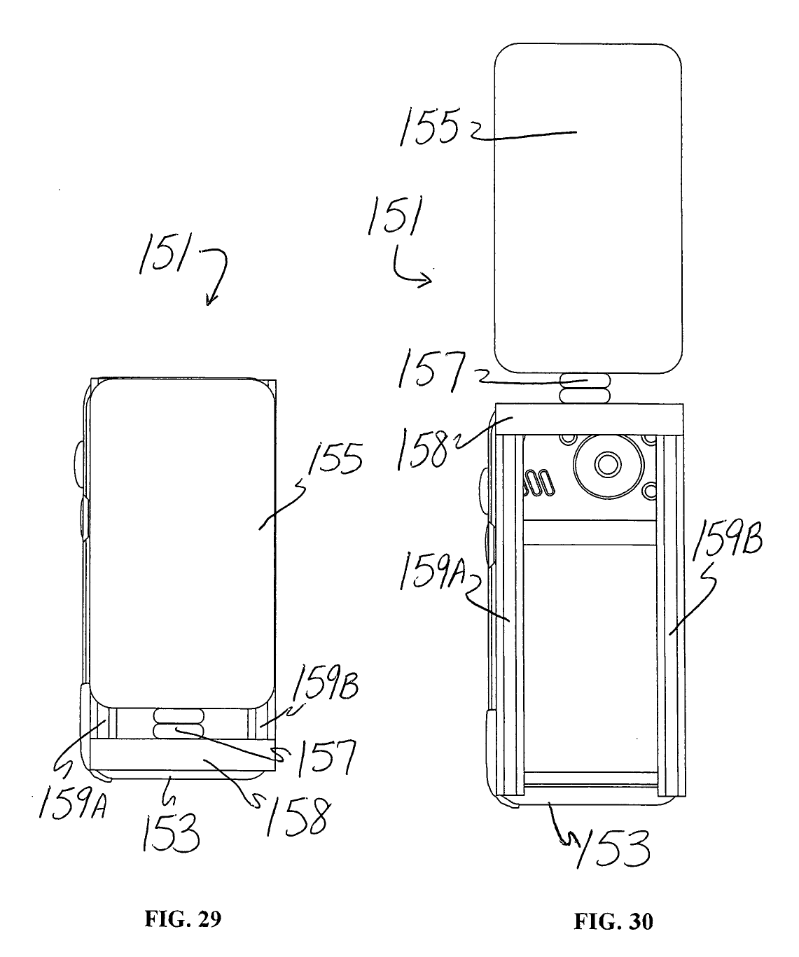

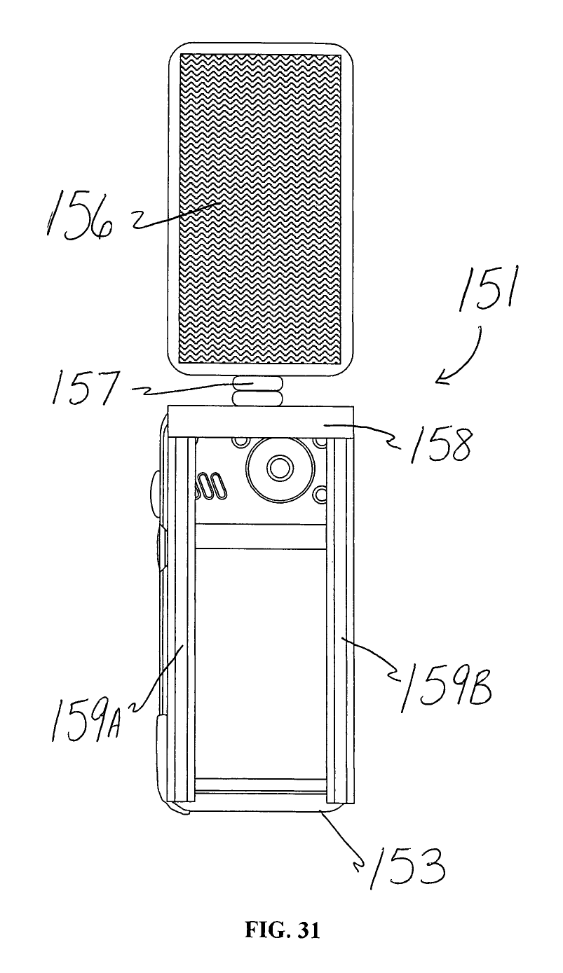

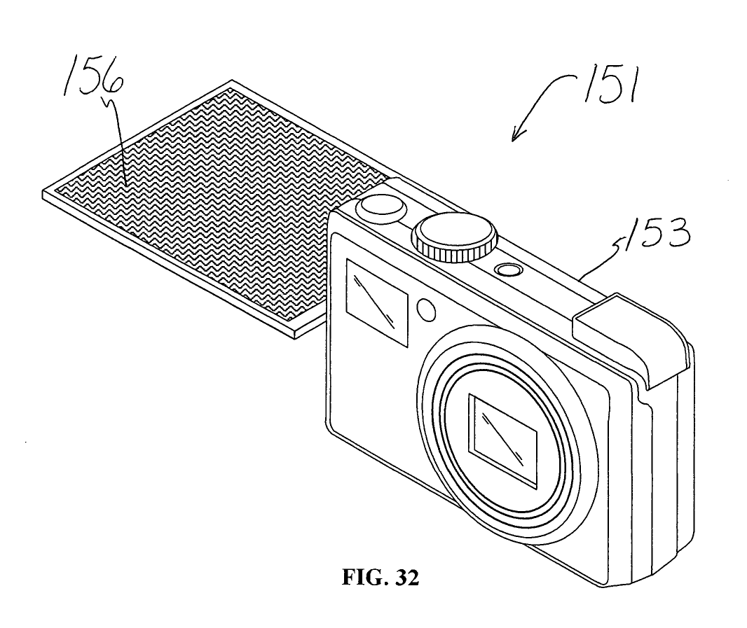

Turning now to FIGS. 29 through 32, another embodiment of the present invention solar powered camera is shown. A solar powered camera 151 includes a digital camera main housing 153. In the preferred embodiment shown in FIGS. 29 through 32, a first track 159A and a second track 159B are attached to the digital camera main housing 153. In other embodiments, only a single track is used, while in still other embodiments three or more tracks are used. A sliding member 158 is slideably attached to the first track 159A and the second track 159B. The sliding member 158 has a first and second rail (not shown) or another type of protrusion adapted to fit within the first track 159A and the second track 159B. It is also possible to design a solar powered camera in which the digital camera main housing 153 is formed in such a way that one or more tracks are molded into the digital camera main housing 153.

In the embodiment shown in FIGS. 29 through 32, the sliding member 158 is attached to a rotational movement mechanism 157, which is attached to at least one solar panel 156. This allows the at least one solar panel 156 to slide past the edge of the digital camera main housing 153 and then to turn about the rotational movement mechanism 157 to an angle suitable for gathering solar energy. One advantage of this embodiment is that, in the closed position, the light-receiving side of the at least one solar panel 156 can be either facing the digital camera main housing 153 for protection, or can face away from the digital camera main housing 153 to allow the light-receiving side of the at least one solar panel 156 to receive light.

The rotational movement mechanism 157 in some preferred embodiments is a ratcheting rotational movement mechanism, which would allow the at least one solar panel to be positioned at one of any pre-determined angles to maximize sun exposure. In some other preferred embodiments, the rotational movement mechanism 157 has sufficient friction to prevent the at least one solar panel 156 from undesired rotation while still allowing rotation by hand when desired.

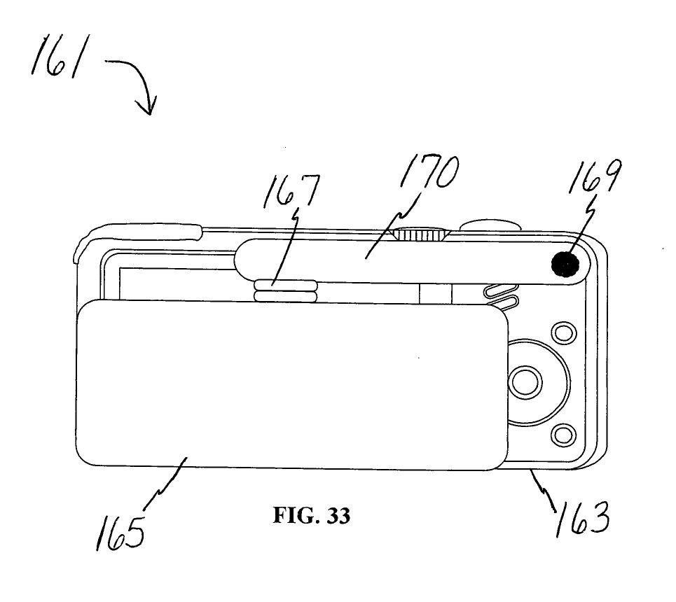

Turning now to FIGS. 33 through 36, another embodiment of the present invention solar powered camera is shown. FIG. 33 shows an embodiment of the solar powered camera 161 in closed position. A solar powered camera 161 includes a digital camera main housing 163. A pivoting connector 169 is attached to digital camera main housing 163. A pivoting arm 170 is attached to the pivoting connector 169 such that the pivoting arm 170 is able to rotate around the pivoting connector 169. In some preferred embodiments, the pivoting arm 170 can fully rotate around the pivoting connector 169. In other preferred embodiments, the pivoting arm 170 has a limited range of rotation around the pivoting connector 169. In some preferred embodiments, the pivoting connector 169 is capable of ratcheting to allow the pivoting arm 170 to be set at any number of predetermined angles. In other preferred embodiments, the pivoting connector 169 has sufficient friction to prevent the pivoting arm 170 from undesired rotation while still allowing a user to rotate the pivoting arm 170 by hand when desired.

A rotational movement mechanism 167 is attached to the pivoting arm 170. This rotational movement mechanism 167 is attached to a solar panel 165 such that the solar panel 165 can rotate along an axis that is not parallel to the axis of rotation of the pivoting arm 170. In some preferred embodiments, the rotational movement mechanism 167 is positioned such that the solar panel 165 fits against the digital camera main housing 163 when in the closed position, as shown in FIG. 33. Although FIG. 33 shows the solar panel 165 having the light-receiving side of the solar panel 165 against the camera in the closed position, it should be clear that in the closed position solar panel 165 can be reversed, exposing the light-receiving side of the solar panel 165. This has the benefit of allowing the user to choose whether the solar powered camera 161 should gather electricity in the closed position or should be protected from impact and other potential damage. As with the pivoting connector 169, in some preferred embodiments the rotational movement mechanism 167 is capable of ratcheting to allow the solar panel 165 to be set to any number of predetermined angles to track the sun. In other preferred embodiments, the rotational movement mechanism 167 has sufficient friction to prevent the solar panel 165 from undesired rotation while still allowing a user to rotate the solar panel 165 when desired.

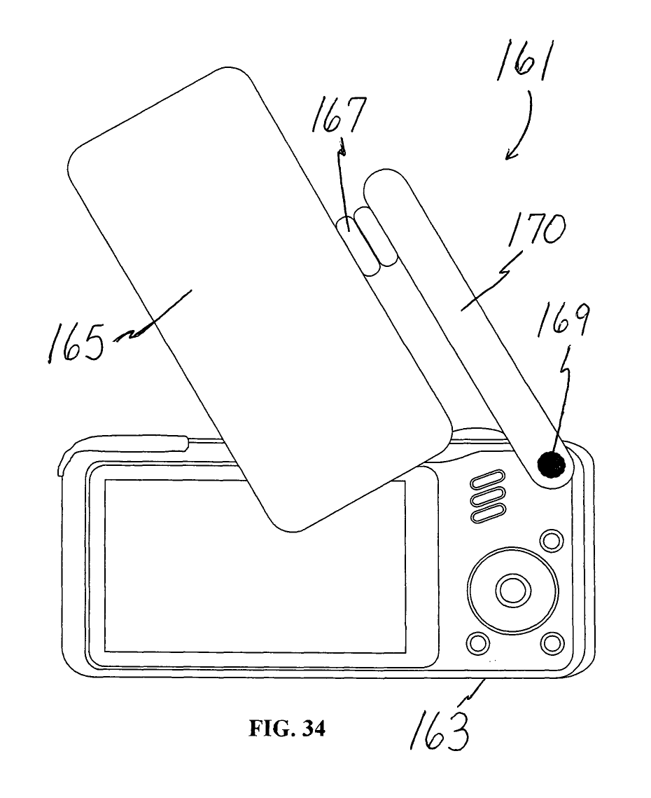

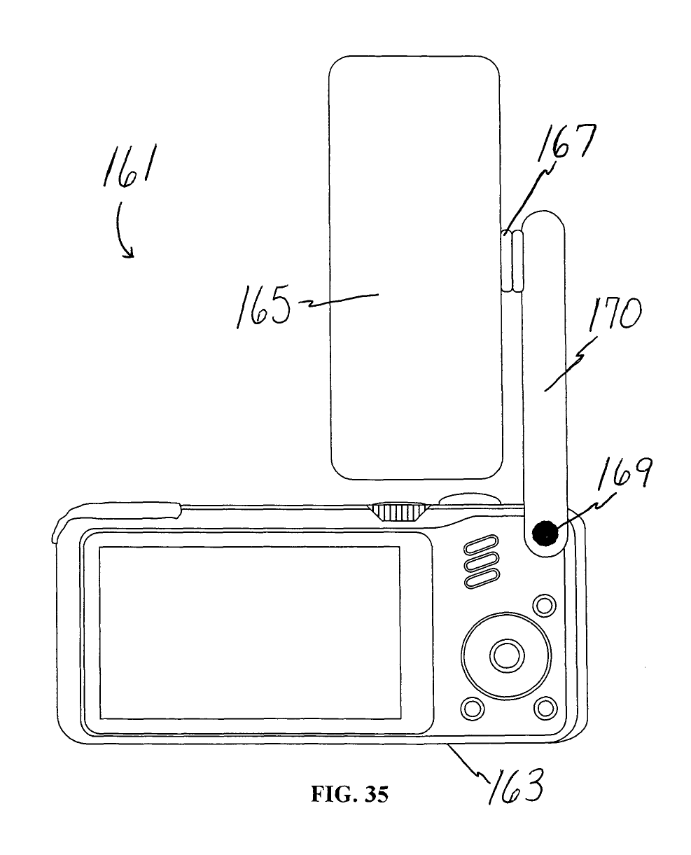

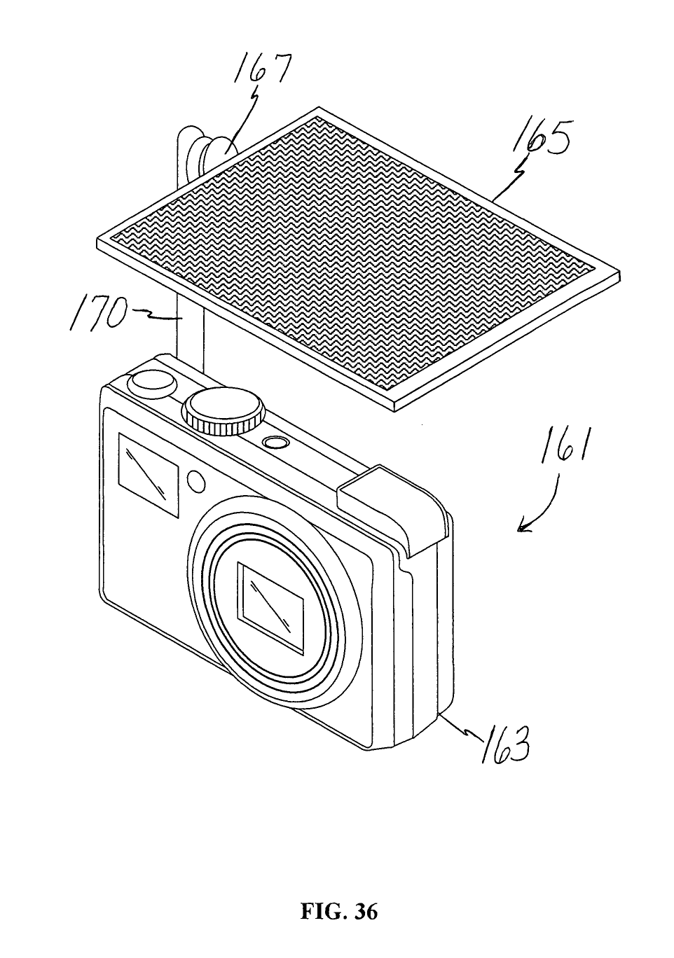

FIG. 34 shows the solar powered camera 161 in a partially opened configuration. Pivoting arm 170 has been rotated upward around pivoting connector 169. Solar panel 165 has not been rotated around rotational movement mechanism 167. FIG. 35 shows the solar powered camera 161 in another configuration. In FIG. 35, pivoting arm 170 has been rotated to a position perpendicular to the closed position shown in FIG. 33. When the pivoting arm is in the position shown in FIG. 35, solar panel 165 has sufficient clearance to rotate past the digital camera main housing 163 around the rotational movement mechanism 167. In FIG. 36, the solar powered camera 161 is shown in an open configuration. The pivoting arm 170 is in approximately the same orientation as shown in FIG. 35. Solar panel 165 has been rotated around rotational movement mechanism 167 to a position in which the light-receiving side of the solar panel 165 is facing upward. The precise angle to which the solar panel 165 is adjusted will vary based upon the position of the sun.

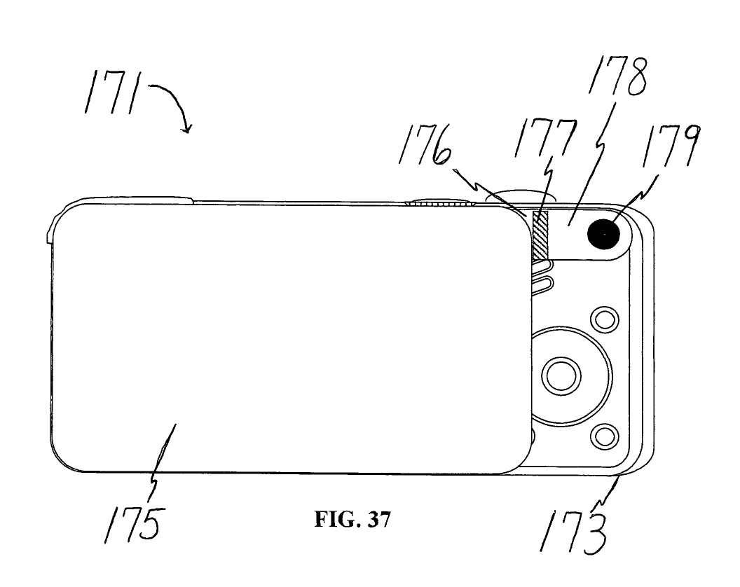

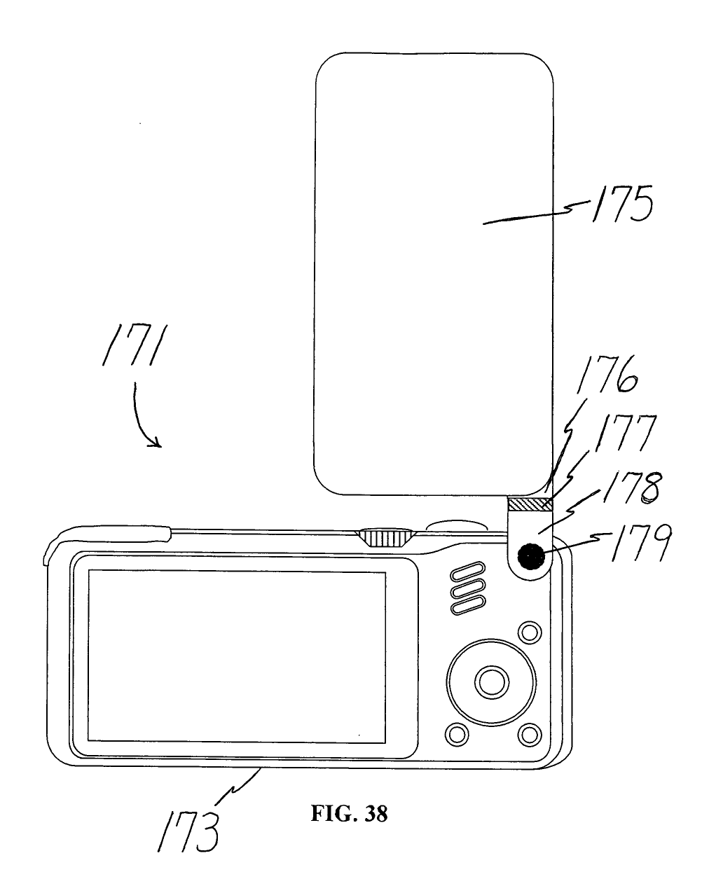

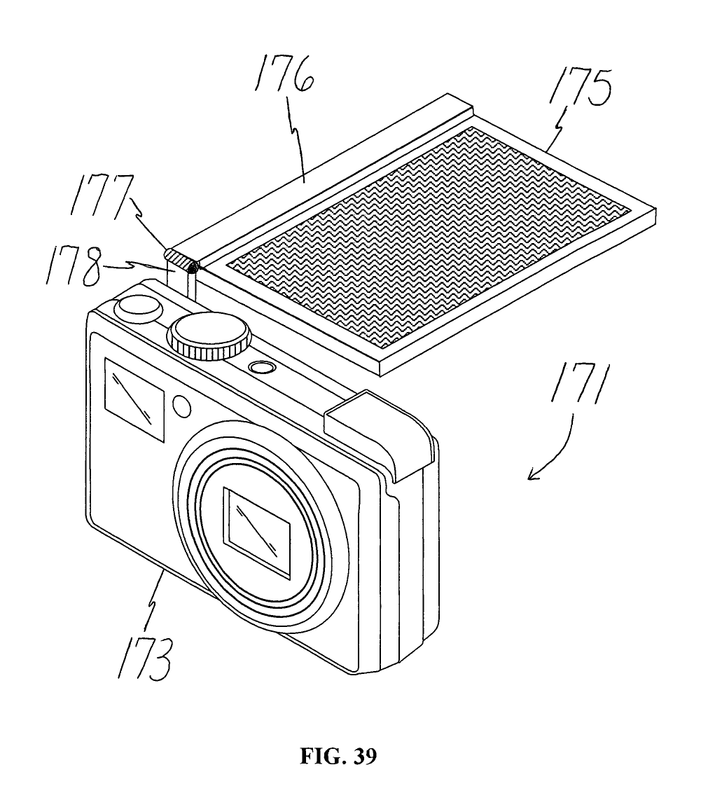

Turning now to FIGS. 37 through 39, another embodiment of the present invention solar powered camera is shown. A solar powered camera 171 includes a digital camera main housing 173. A pivoting connector 179 is connected to the digital camera main housing 173. A pivoting arm 178 is connected to the pivoting connector 179 such that the pivoting arm 178 can rotate around the pivoting connector 179. In some preferred embodiments of the solar powered camera 171, the pivoting arm 178 can completely rotate around the pivoting connector 179. In other preferred embodiments of the solar powered camera 171, the pivoting arm 178 has a limited range of rotation around the pivoting connector 179. In some preferred embodiments, the pivoting connector 179 is capable of ratcheting to allow the pivoting arm 178 to be set at any number of predetermined angles. In other preferred embodiments, the pivoting connector 179 has sufficient friction to prevent the pivoting arm 178 from undesired rotation while still allowing a user to rotate the pivoting arm 178 when desired.

A hinge 177 is attached to the pivoting arm 178. A hinged arm 176 is connected to the hinge 177 such that the hinged arm 176 can rotate around the hinge 177. In some preferred embodiments, the hinge 177 is capable of ratcheting to allow the hinged arm 176 to be set at any number of predetermined angles. In other preferred embodiments, the hinge 177 has sufficient friction to prevent the hinged arm 176 from undesired rotation while still allowing a user to rotate the hinged arm 176 when desired. The hinged arm 176 is attached to the solar panel 175 such that as the hinged arm 176 moves around the hinge 177, the solar panel 175 also moves around the hinge. In some preferred embodiments of the solar powered camera 171, the hinged arm 176 is integrally formed as part of the solar panel 175. Although the solar panel 175 is pictured in FIG. 37 as having its light-receiving side facing inward toward the digital camera main housing 173, in other preferred embodiments the light-receiving side of the solar panel 175 faces outward when in the closed position. Although this embodiment exposes the light-receiving side of the solar panel 175 to impact or other damage, it has the advantage of generating solar power even when the solar panel 175 is in the closed position. In other preferred embodiments, the solar panel 175 has light-receiving surfaces on more than one side of the solar panel 175.

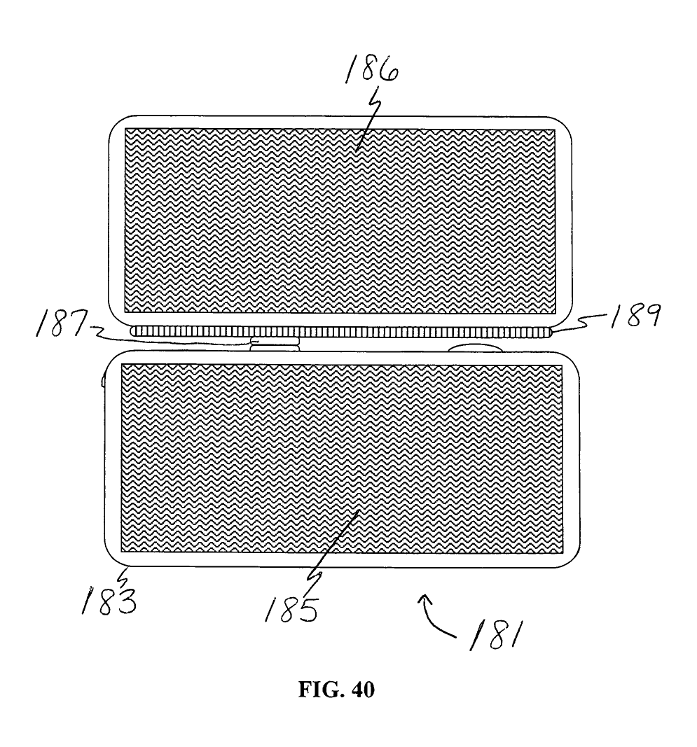

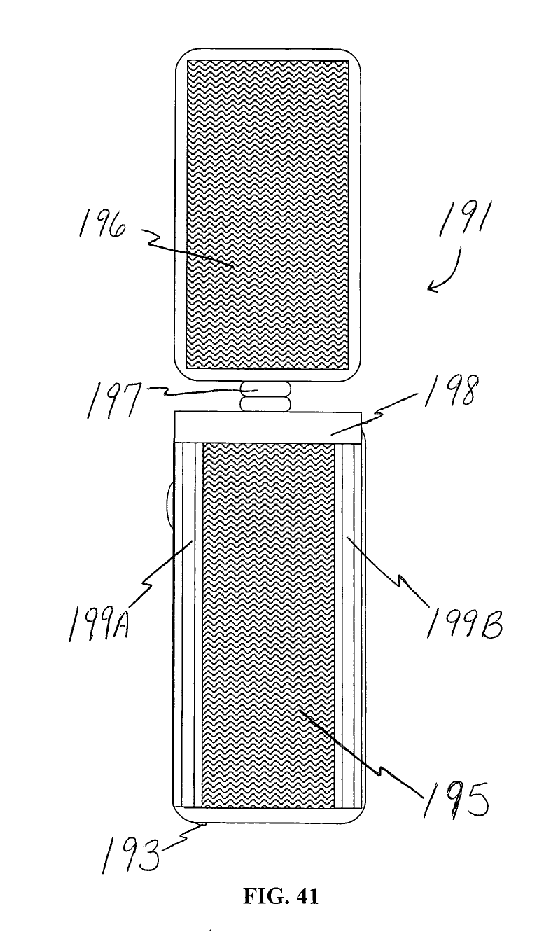

FIG. 40 shows another embodiment of the present invention solar powered camera. The embodiment shown in FIG. 40 is similar to the embodiment shown in FIGS. 24 through 28 and described above with reference to those Figures. In this embodiment, solar powered camera 181 includes a solar panel 186 which is movably attached to the digital camera main housing 183 by two connection mechanisms: a rotational movement mechanism 187 and a hinge 189. Additionally, the embodiment shown in FIG. 41 includes a solar panel 185 affixed to the back of the camera. As with the embodiment shown in FIGS. 24 through 28, the rotational movement mechanism 187 and the hinge 189 may have ratcheting mechanisms to allow the rotational movement mechanism 187 and the hinge 189 to be set at any number of pre-determined positions, or they may have sufficient friction to prevent undesired movement while allowing a user to adjust the rotational movement mechanism 187 and the hinge 189 by hand.

FIG. 41 shows another embodiment of the present invention solar powered camera. The embodiment shown in FIG. 41 is similar to the embodiment shown in FIGS. 29 through 32 and described above with reference to those Figures. In this embodiment, solar powered camera 191 includes a main housing 193. On the back of main housing 193 is affixed a solar panel 195. Two tracks 199A and 199B are permanently attached to the main housing 193. In some embodiments one track is used, while in still other embodiments three or more tracks are used. In some embodiments, solar panel 195 is between the two tracks 199A and 199B and the main housing 193. A sliding member 198 is slideably attached to the tracks. A rotational movement mechanism 197 connects sliding member 198 to solar panel 196 and allows solar panel 196 to rotate. The rotational movement mechanism may ratchet, allowing solar panel 196 to be set at any number of pre-determined positions.

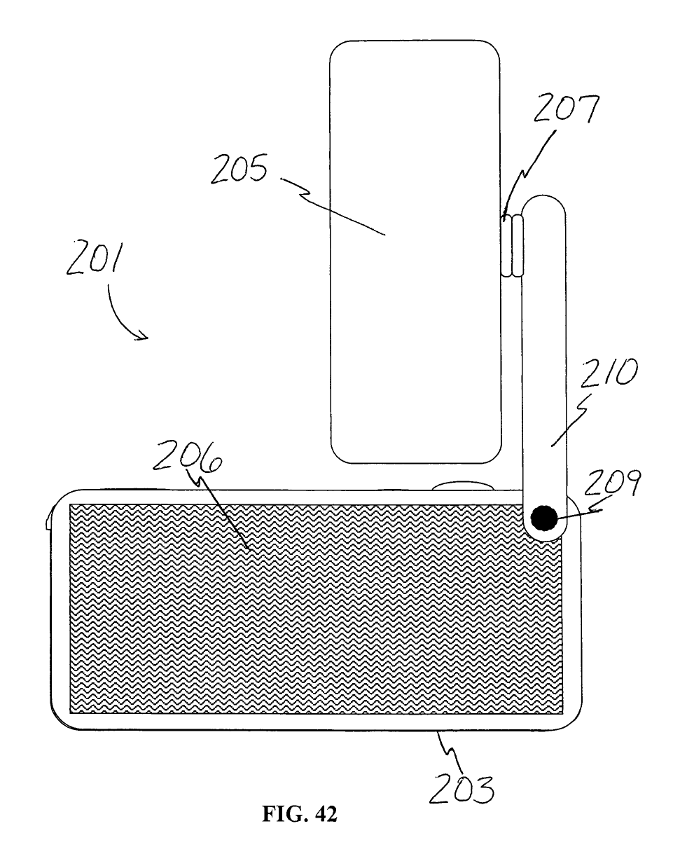

FIG. 42 shows another embodiment of the present invention solar powered camera. The embodiment shown in FIG. 42 is similar to the embodiment shown in FIGS. 33 through 36 and described above with reference to those Figures. In this embodiment, solar powered camera 201 includes a main housing 203. Solar panel 206 is affixed to the back of the main housing 203. A pivoting connector 209 is attached to digital camera main housing 203. A pivoting arm 210 is attached to the pivoting connector 209 such that the pivoting arm 210 is able to rotate around the pivoting connector 209. In some preferred embodiments, the pivoting connector 209 is capable of ratcheting to allow the pivoting arm 210 to be set at any number of predetermined angles. In other preferred embodiments, the pivoting connector 179 has sufficient friction to prevent the pivoting arm 170 from undesired rotation while still allowing a user to rotate the pivoting arm 170 by hand when desired. A rotational movement mechanism 167 is attached to the pivoting arm 170. This rotational movement mechanism 167 is attached to a solar panel 165 such that the solar panel 165 can rotate along an axis that is not parallel to the axis of rotation of the pivoting arm 170. As with the pivoting connector 169, in some preferred embodiments the rotational movement mechanism 167 is capable of ratcheting to allow the solar panel 165 to be set to any number of predetermined angles to track the sun. In other preferred embodiments, the rotational movement mechanism 167 has sufficient friction to prevent the solar panel 165 from undesired rotation while still allowing a user to rotate the solar panel 165 when desired.

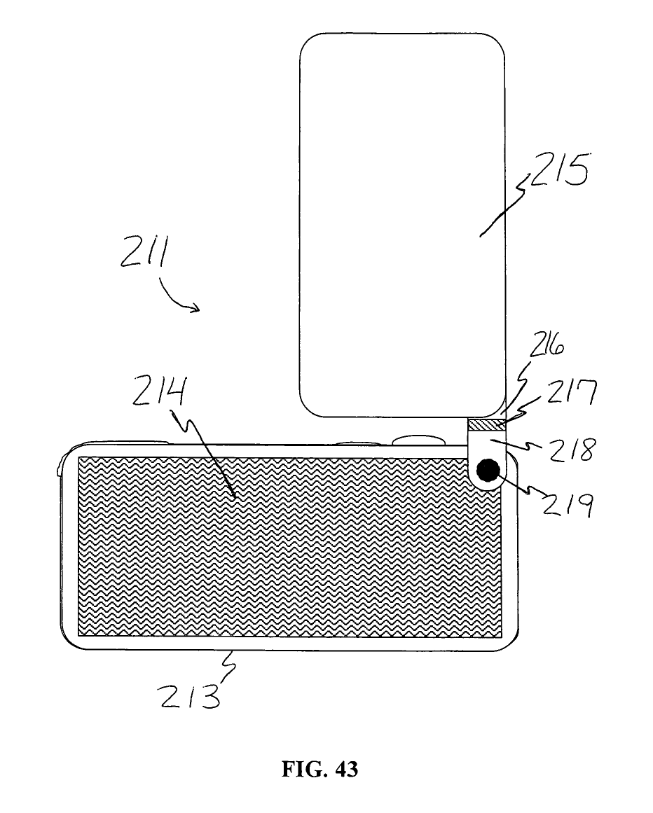

FIG. 43 shows another embodiment of the present invention solar powered camera. The embodiment shown in FIG. 43 is similar to the embodiment shown in FIGS. 37 through 39 and described above with reference to those Figures. In this embodiment, solar powered camera 211 includes a main housing 213. Solar panel 214 is affixed to the back of the main housing 213. A pivoting connector 219 is connected to the digital camera main housing 213. A pivoting arm 218 is connected to the pivoting connector 219 such that the pivoting arm 218 can rotate around the pivoting connector 219. A hinge 217 is attached to the pivoting arm 218. A hinged arm 216 is connected to the hinge 217 such that the hinged arm 216 can rotate around the hinge 217. The hinged arm 216 is attached to the solar panel 215 such that as the hinged arm 216 moves around the hinge 217, the solar panel 215 also moves around the hinge. In some preferred embodiments of the solar powered camera 211, the hinged arm 216 is integrally formed as part of the solar panel 215. Although the solar panel 215 is pictured in FIG. 43 as having its light-receiving side facing inward toward the digital camera main housing 213, in other preferred embodiments the light-receiving side of the solar panel 215 faces outward when in the closed position. Although this embodiment exposes the light-receiving side of the solar panel 215 to impact or other damage, it has the advantage of generating solar power even when the solar panel 215 is in the closed position. In other preferred embodiments, the solar panel 215 has light-receiving surfaces on more than one side of the solar panel 215.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A solar powered camera, comprising:
a) a digital camera main housing;
b) digital camera internal mechanisms, including imaging and storage processors located within said main housing, imaging and storage controls, and a lens connected to said imaging processor and located on said main housing;
c) a rechargeable power storage unit connected to said digital camera internal mechanisms; and,
d) at least one solar cell panel connected to said rechargeable power storage unit and movably connected to said main housing, said at least one solar cell panel having a first position, being a closed position, and having a second position, being an open position;
wherein said at least one solar cell panel is movable from said first position to said second position for solar recharging of said rechargeable power storage unit, and is movable from said second position to said first position for storage.

2. The solar powered camera of claim 1 wherein said at least one solar cell panel is hingedly connected to said main housing for flip up movement from said first position to said second position and subsequently from said second position to said first position.

3. The solar powered camera of claim 1 wherein said at least one solar cell panel is slideably connected to said main housing for sliding movement from said first position to said second position and subsequently from said second position to said first position.

4. The solar powered camera of claim 1 wherein said at least one solar cell panel is pivotally connected to said main housing so as to allow single plane rotation of said at least one solar cell panel for pivoting rotational movement from said first position to said second position and subsequently from said second position to said first position.

5. The solar powered camera of claim 1 wherein said at least one solar cell is telescopically connected to said main housing for telescopic movement from said first position to said second position and subsequently from said second position to said first position.

6. The solar powered camera of claim 1 wherein said at least one solar cell panel is connected to said main housing by a compound movement connection that includes a hinge and a rotational connector connected to said hinge, wherein one of said hinge and said rotational connector is connected to said at least one solar cell panel and the other of said hinge and rotational connector is connected to said main housing such that said at least one solar cell panel is movable via flip up movement along said hinge, and by rotational movement in a different direction along said rotational connector, from said first position to said second position and subsequently from said second position to said first position.

7. The solar powered camera of claim 1 wherein said at least one solar cell panel is connected to said main housing by a compound movement connection that includes a sliding mechanism and a rotational connector connected to said sliding mechanism, wherein one of said sliding mechanism and said rotational connector is connected to said at least one solar cell panel and the other of said sliding mechanism and rotational connector is connected to said main housing such that said at least one solar cell panel is movable via sliding movement, and by rotational movement in a different direction along said rotational connector, from said first position to said second position and subsequently from said second position to said first position.

8. The solar powered camera of claim 7 wherein said sliding mechanism is at least one track and rail.

9. The solar powered camera of claim 1 wherein said at least one solar cell panel is connected to said main housing by a compound movement connection that includes a pivot point and a rotational connector connected to said pivot point, wherein one of said pivot point and said rotational connector is connected to said at least one solar cell panel and the other of said pivot point and rotational connector is connected to said main housing such that said at least one solar cell panel is movable via pivoting rotational movement, and by rotational movement in a different direction along said rotational connector, from said first position to said second position and subsequently from said second position to said first position.

10. The solar powered camera of claim 1 wherein said at least one solar cell panel is connected to said main housing by a compound movement connection that includes a pivot point and a hinge connected to said pivot point, wherein one of said pivot point and said hinge is connected to said at least one solar cell panel and the other of said pivot point and hinge is connected to said main housing such that said at least one solar cell panel is movable via pivoting rotational movement, and by flip up movement in a different direction along said hinge, from said first position to said second position and subsequently from said second position to said first position.

11. A solar powered camera, comprising:
a) a digital camera main housing;
b) digital camera internal mechanisms, including imaging and storage processors located within said main housing, imaging and storage controls, and a lens connected to said imaging processor and located on said main housing;
c) a rechargeable power storage unit connected to said digital camera internal mechanisms; and,
d) at least two solar cell panels connected to said rechargeable power storage unit, wherein at least one of said at least two solar cell panels is movably connected to said main housing, said at least one solar cell panel having a first position, being a closed position, and having a second position, being an open position;
wherein said at least one solar cell panel is movable from said first position to said second position for solar recharging of said rechargeable power storage unit, and is movable from said second position to said first position for storage.

12. The solar powered camera of claim 11 wherein said at least one of said at least two solar cell panels is hingedly connected to said main housing for flip up movement from said first position to said second position and subsequently from said second position to said first position.

13. The solar powered camera of claim 11 wherein said at least one of said at least two solar cell panels is slideably connected to said main housing for sliding movement from said first position to said second position and subsequently from said second position to said first position.

14. The solar powered camera of claim 11 wherein said at least one of said at least two solar cell panels is pivotally connected to said main housing so as to allow single plane rotation of said at least two solar cell panels for pivoting rotational movement from said first position to said second position and subsequently from said second position to said first position.

15. The solar powered camera of claim 11 wherein said at least one of said at least two solar cell panels is telescopically connected to said main housing for telescopic movement from said first position to said second position and subsequently from said second position to said first position.

16. The solar powered camera of claim 11 wherein said at least one of said at least two solar cell panels is connected to said main housing by a compound movement connection that includes a hinge and a rotational connector connected to said hinge, wherein one of said hinge and said rotational connector is connected to said at least one of said at least two solar cell panels and the other of said hinge and rotational connector is connected to said main housing such that said at least one of said at least two solar cell panels is movable via flip up movement along said hinge, and by rotational movement in a different direction along said rotational connector, from said first position to said second position and subsequently from said second position to said first position.

17. The solar powered camera of claim 11 wherein said at least one of said at least two solar cell panels is connected to said main housing by a compound movement connection that includes a sliding mechanism and a rotational connector connected to said sliding mechanism, wherein one of said sliding mechanism and said rotational connector is connected to said at least one of said at least two solar cell panels and the other of said sliding mechanism and rotational connector is connected to said main housing such that said at least one of said at least two solar cell panels is movable via sliding movement, and by rotational movement in a different direction along said rotational connector, from said first position to said second position and subsequently from said second position to said first position.

18. The solar powered camera of claim 17 wherein said sliding mechanism is at least one track and rail.

19. The solar powered camera of claim 11 wherein said at least one of said at least two solar cell panels is connected to said main housing by a compound movement connection that includes a pivot point and a rotational connector connected to said pivot point, wherein one of said pivot point and said rotational connector is connected to said at least one of said at least two solar cell panels and the other of said pivot point and rotational connector is connected to said main housing such that said at least one of said at least two solar cell panels is movable via pivoting rotational movement, and by rotational movement in a different direction along said rotational connector, from said first position to said second position and subsequently from said second position to said first position.

20. The solar powered camera of claim 11 wherein said at least one of said at least two solar cell panels is connected to said main housing by a compound movement connection that includes a pivot point and a hinge connected to said pivot point, wherein one of said pivot point and said hinge is connected to said at least one of said at least two solar cell panels and the other of said pivot point and hinge is connected to said main housing such that said at least one of said at least two solar cell panels is movable via pivoting rotational movement, and by flip up movement in a different direction along said hinge, from said first position to said second position and subsequently from said second position to said first position.
